(19) United States
(12) Patent Application Publication
(10) Pub. No.: US 2016/0078571 A1
(43) Pub. Date: Mar. 17, 2016

(54) Hotel Room Restaurant Delivery System

(71) Applicant: DoDine, Inc., Hayward, CA (US)

(72) Inventor: Bikramjit Singh, Hayward, CA (US)

(73) Assignee: DoDine, Inc.

(21) Appl. No.: 14/851,270

(22) Filed: Sep. 11, 2015

Related U.S. Application Data
(60) Provisional application No. 62/049,509, filed on Sep. 12, 2014.

(51) Int. Cl. G06Q 50/12; G06Q 30/06; G06Q 50/28; G06Q 20/38

(52) U.S. Cl. CPC G06Q 50/12; G06Q 20/387; G06Q 30/0633; G06Q 30/0639; G06Q 30/0641; G06Q 50/28

(57) ABSTRACT

A computer implemented method and a hotel room restaurant delivery system (HRRDS) for ordering food from a restaurant for delivery to a hotel room via an electronic device in the hotel room are provided. The HRRDS determines and renders information, advertisements, and promotions of restaurants proximal to the hotel room from a restaurant network on the electronic device based on a food urgency level and predetermined user criteria. The HRRDS receives a restaurant selection and a food selection of food items from an associated food menu through one or more interface elements. The HRRDS generates a sale order with user information and a net payable amount for the selected food items and performs one or more actions associated with the sale order, in communication with a restaurant management and delivery system of a selected restaurant via a communication network, for delivering the selected food items to the hotel room.

### CROSS-REFERENCE TO RELATED APPLICATIONS

This application claims priority to and the benefit of provisional patent application No. 62/049,509 titled “Hotel Room Restaurant Delivery System”, filed in the United States Patent and Trademark Office on Sep. 12, 2014. The specification of the above referenced patent application is incorporated herein by reference in its entirety.

### BACKGROUND

Hotels offer their guests multiple facilities to make their stay pleasant. In addition to providing the guests with various amenities, hotels also offer room service. A typical room service comprises, for example, fulfilling a guest's requests for beverages, food, etc. A guest staying at a hotel uses a menu provided by the hotel to order food and receive room service over a phone in the hotel room where the guest is accommodated. The guest may not find food items of his/her choice in the menu provided by the hotel where the guest is staying. Moreover, a typical room service structure of a hotel does not allow the guest to track progress of an order made through the room service structure and the guest has to wait for an unknown period of time before receiving the food ordered.

Some hotels do not offer food service and the guest may have to search for a restaurant online and then physically leave the hotel premises to dine at a restaurant or take away food from the restaurant to dine in his/her hotel room. Moreover, it is difficult to obtain food items of the guest's choice based on the guest's urgency for a particular type of food at an urgent time. Furthermore, ordering food offline requires a guest to stand in a queue and wait for a long time to get a table at the restaurant or receive the food order to take away, which is time consuming. Guests at a hotel typically prefer to stay in their rooms and engage in other activities rather than venture out to find a restaurant at a different location from the hotel and spend time in a queue to order their food at the restaurant. Efficient food service is a requirement when a guest selects a hotel and failure to meet expectations of the guest results in poor feedback to the hotel.

Having to leave the hotel premises and spend time standing in a queue for ordering food is time consuming and not guest friendly as a guest needs to search for information of the nearest available restaurant and then go to the restaurant to dine. The conventional hotel food service does not meet the requirements of the guest as there is no option for the guest to choose beyond the available meal options provided by the hotel. The conventional food service provided by a hotel may not have sufficient information on restaurants nearest to the hotel and types of food offered by the restaurants nearest to the hotel. Moreover, hotels do not provide an option for guests to review meal options available in restaurants outside the hotel. Furthermore, hotels do not provide options for guests to place a meal order to a restaurant located outside the hotel for delivery to their hotel rooms. The conventional food service provided by a hotel also does not provide an in-room dining option to the guests for orders placed from another restaurant outside the hotel. Furthermore, guests at a hotel do not have access to offers and promotions of restaurants outside of the hotel, thereby requiring them to leave the hotel premises and spend a large amount of money and time at a restaurant that may be close to their hotel.

Hence, there is a long felt but unresolved need for a computer implemented method and system that allows a guest at a hotel to order food from a restaurant proximal to the hotel for delivery to a hotel room via an electronic device stationed in the hotel room. Moreover, there is a need for a computer implemented method and system that determines an urgency level of a guest's food requirement, displays a list of available restaurants near the hotel along with information on time specific cuisines in the displayed list of available restaurants, and ensures that the food is delivered to the hotel room based on the determined urgency level. Furthermore, there is a need for a computer implemented method and system that determines a guest's food preferences and provides information on offers and promotions of restaurants proximal to the hotel based on the guest's food preferences to allow the guest to purchase food items of his/her choice at reduced costs. Furthermore, there is a need for a computer implemented method and system that allows guests to track the status of their orders until the food is delivered to their hotel rooms.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended to determine the scope of the claimed subject matter.

The computer implemented method and system disclosed herein addresses the above mentioned needs for allowing a guest at a hotel to order food from a restaurant proximal to the hotel for delivery to a hotel room via an electronic device stationed in the hotel room. Moreover, the computer implemented method and system disclosed herein determines an urgency level of the guest's food requirement, displays a list of available restaurants near the hotel along with information on time specific cuisines in the displayed list of available restaurants, and ensures that the food is delivered to the hotel room based on the determined urgency level. Furthermore, the computer implemented method and system disclosed herein determines a guest's food preferences and provides information on offers and promotions of restaurants proximal to the hotel based on the guest's food preferences to allow the guest to purchase food items of his/her choice at reduced costs. Furthermore, the computer implemented method and system disclosed herein allows guests to make a payment for orders of their choice and track the status of their orders until the food is delivered to their hotel rooms. Using the computer implemented method and system disclosed herein, hotels can offer enhanced guest services by providing a food service responsive to the urgency level of a guest's requirement for food, and by providing in-room dining options from nearby available restaurants, which allow the guest to select a time specific food type, that is, select a food type based on the preparation and delivery time of that particular food, to select a restaurant to order that particular food with their desired payment method, to avail offers provided by nearby available restaurants, and to track the status of the order until the food is delivered to the hotel room.

The computer implemented method and system disclosed herein employs a hotel room restaurant delivery system (HRRDS) comprising at least one processor configured to execute computer program instructions for ordering food from a restaurant for delivery to a hotel room via an electronic device stationed in the hotel room. The HRRDS allows a user to place an order from and pay through a hotel room based electronic device. A user, for example, a guest at the hotel, initializes the HRRDS via a graphical user interface (GUI) of the electronic device stationed in the user's hotel room. The HRRDS determines an urgency level of the user's food requirement by processing and transforming input data received from the electronic device. The HRRDS determines and renders multiple time specific food type options on the GUI of the electronic device based on the determined urgency level of the user's food requirement. The HRRDS receives and processes a food type selection of one of the time specific food type options from the electronic device through one or more of multiple interface elements via the GUI of the electronic device.

The hotel room restaurant delivery system (HRRDS) determines and renders information, advertisements, and promotions of multiple restaurants proximal to the hotel room or the hotel from a restaurant network on the graphical user interface (GUI) of the electronic device based on the received and processed food type selection of one of the time specific food type options and predetermined user criteria. The HRRDS receives and processes a restaurant selection of one of the restaurants and a food selection of one or more food items from a food menu associated with the received and processed restaurant selection through one or more of the interface elements via the GUI of the electronic device. The HRRDS generates and renders a sale order comprising user information and a net payable amount for one or more food items based on the received and processed restaurant selection and the received and processed food selection on the GUI of the electronic device. The HRRDS performs one or more actions associated with the sale order, in communication with a restaurant management and delivery system of one of the restaurants based on the received and processed restaurant selection via a communication network, for the delivery of the food items based on the received and processed food selection to the hotel room.

In one or more embodiments, related systems comprise circuitry and/or programming for effecting the methods disclosed herein; the circuitry and/or programming can be any combination of hardware, software, and/or firmware configured to effect the methods disclosed herein depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIGS. 1A-1B illustrate a computer implemented method for ordering food from a restaurant for delivery to a hotel room via an electronic device stationed in the hotel room.

FIG. 2 exemplarily illustrates a process flow diagram showing an interaction between a hotel guest and a restaurant for ordering and delivery of food to a hotel room via an electronic device.

FIG. 3 exemplarily illustrates a process flow diagram comprising the steps performed by a hotel room restaurant delivery system for allowing a user to order food from a restaurant and processing a sale order for delivery of the food to a hotel room.

FIG. 4 exemplarily illustrates a computer implemented system for ordering food from a restaurant for delivery to a hotel room via an electronic device stationed in the hotel room.

FIG. 5 exemplarily illustrates the hardware architecture of the hotel room restaurant delivery system for ordering food from a restaurant for delivery to a hotel room via an electronic device stationed in the hotel room.

### DETAILED DESCRIPTION OF THE INVENTION

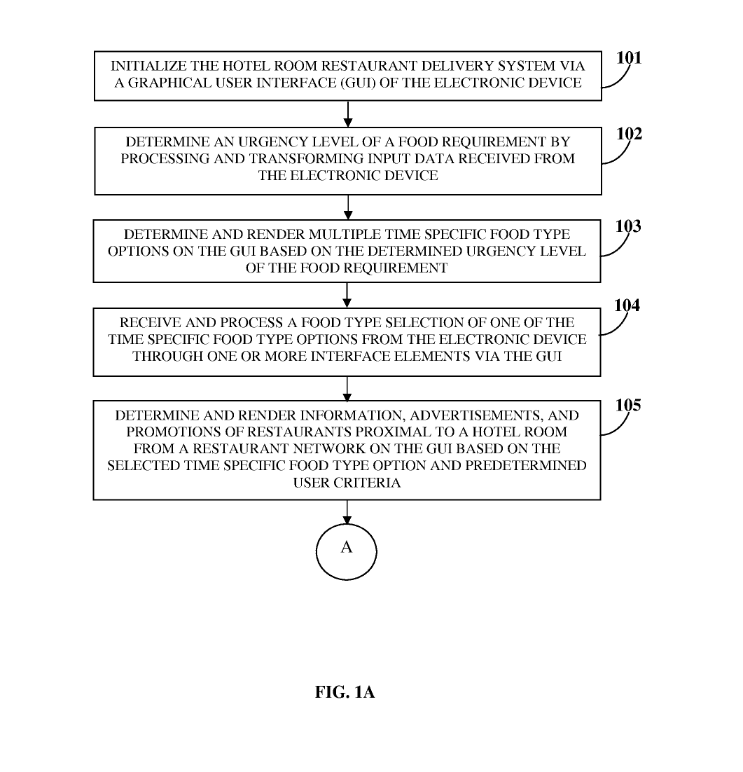

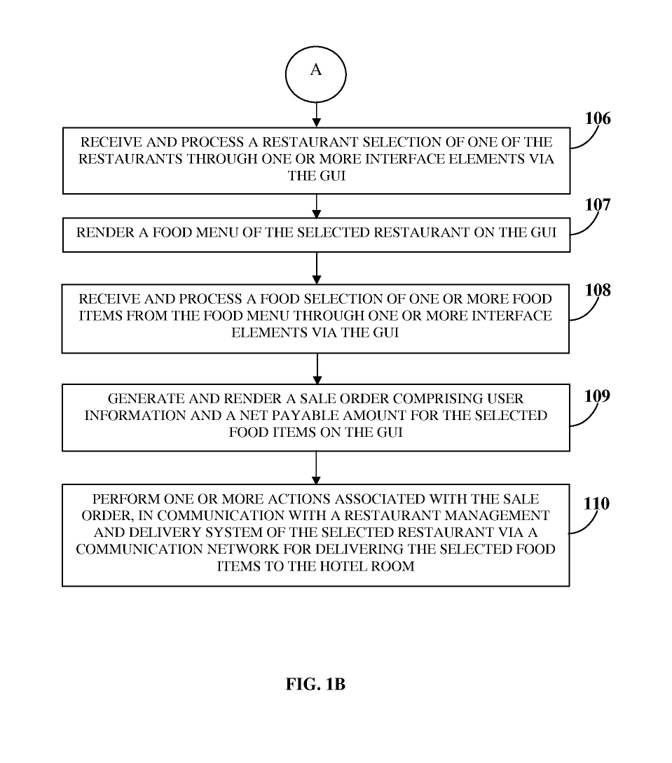

FIGS. 1A-1B illustrate a computer implemented method for ordering food from a restaurant for delivery to a hotel room via an electronic device stationed in the hotel room. The electronic device is a computing device, for example, a personal computer, a tablet computing device, a mobile computer, a mobile phone, a smart phone, a portable computing device, a portable electronic device, a laptop, a personal digital assistant, etc. The electronic device is configured to be positioned securely, for example, on a desktop surface or a nightstand top surface in the hotel room. The computer implemented method disclosed herein employs a hotel room restaurant delivery system (HRRDS) comprising at least one processor configured to execute computer program instructions for ordering food from a restaurant for delivery to a hotel room via the electronic device stationed in the hotel room. In an embodiment, the HRRDS is installed in the electronic device. In an embodiment, the electronic device is locked to run an operating system and software applications associated with the HRRDS. The electronic device connects to designated servers of the HRRDS via a communication network, for example, the internet. In another embodiment, the HRRDS is a web based application software accessible from a web browser via the communication network. In another embodiment, the HRRDS is a multi-platform software application configured to be implemented on multiple operating systems, for example, the iOS operating system of Apple Inc., the Android™ operating system of Google Inc., installed on the electronic device. In another embodiment, the HRRDS is configured as a backend server that communicates with a hotel room restaurant delivery application (HRRDA) installed on the electronic device via the communication network. In an embodiment, the HRRDA is a mobile application that can be downloaded and executed on a mobile device. The HRRDS is a commercial network platform targeted, for example, at the food service industry. The HRRDS brings together restaurants and the dining public by leveraging information about what these restaurants offer and matching this information with users who may have a use or need for this information. The HRRDS is a specialized hardware and software system used by hotels to allow their guests to order food from nearby restaurants and have the ordered food delivered to their hotel rooms.

The hotel room restaurant delivery system (HRRDS) enables a user, for example, a guest at a hotel to order food items and other items, for example, products and/or services via a graphical user interface (GUI) of the electronic device stationed in the hotel room. As used herein, “graphical user interface” refers to an interface that allows users, for example, guests of a hotel to interact with the electronic device using one or more interface elements for providing their inputs. Also, as used herein, “interface elements” refer to software or hardware implemented input objects, for example, switches or buttons such as physical push buttons, touch buttons or tactile buttons, wheels, touch pads, etc., provided on the electronic device, window interfaces, text containers and graphics such as list boxes, check boxes, icons, screen icon type touch buttons, chat interfaces, hyperlinks, etc., provided on the GUI of the electronic device, etc., that are capable of receiving an input from a user or capturing an application of pressure from the user. The interface elements are configured to receive inputs from users with disabilities via the GUI of the electronic device. For example, in an embodiment, the HRRDS provides a voice interaction facility via a button configured on the electronic device to enable visually impaired users to transact food orders with a customer service representative of the HRRDS. In another embodiment, the HRRDS provides a chat interface accessible via the GUI of the electronic device for enabling hearing impaired users to transact food orders. In an embodiment, a timepiece with an alarm clock is provided on the electronic device for scheduling wake up calls and/or a delivery time of food items ordered by a user through the electronic device.

A user initializes 101 the hotel room restaurant delivery system (HRRDS) via the graphical user interface (GUI) of the electronic device stationed in the hotel room using one or more of the interface elements. In the computer implemented method disclosed herein, when a user initializes the HRRDS via the GUI of the electronic device, in an embodiment, the HRRDS determines 102 an urgency level of the user's food requirement by processing and transforming input data received from the electronic device. The input data used by the HRRDS for determining the urgency level of the user's food requirement comprises, for example, a time of each successive input made by the user and received via the GUI of the electronic device. The HRRDS determines a time difference between successive inputs received from the user via the GUI of the electronic device and compares the determined time difference with a predefined urgency threshold. The predefined urgency threshold is a threshold value defined by the HRRDS to determine whether a food requirement is urgent and must be fulfilled at the shortest possible time or whether a food requirement can be fulfilled at a delayed time or a time scheduled by the user. In an embodiment, the input data comprises an explicit indication of urgency of the food requirement received from the user via the GUI of the electronic device.

In an embodiment, the hotel room restaurant delivery system (HRRDS) determines the urgency level of the food requirement to identify the type of food required by the user, for example, based on time required to prepare the food and/or time required to deliver the food to the user's hotel room. The type of food comprises, for example, fast food, food that can be delivered at a later time, food that can be delivered at a time scheduled by the user, food that can be delivered at the shortest possible time, etc. When a user, for example, a hotel guest initiates the HRRDS via the graphical user interface (GUI) of the electronic device, the HRRDS determines the urgency level of the hotel guest's food requirement based on an analysis of the hotel guest's inputs into the HRRDS. For example, the HRRDS detects each input made by the hotel guest and records the time between each successive input. The hotel guest may use an input device, for example, a keyboard, a computer mouse, or one or more of the interface elements on the electronic device to enter inputs into the HRRDS. The HRRDS records the time, for example, at each successive keystroke, at each successive computer mouse click, etc. The HRRDS then computes the time difference between, for example, the first input and the second input, the time taken to respond to a new display and navigate to the next display on the GUI, etc. The HRRDS compares the computed time difference with the predefined urgency threshold to identify the type of food required by the user. For example, if the predefined urgency threshold is 10 milliseconds (ms) and the computed time difference is less than 10 ms, the HRRDS determines that the user wants food urgently, and searches for restaurants that are proximal to the hotel and provide fast food.

The graphical user interface (GUI) of the electronic device receives input data, for example, a user's keystrokes, computer mouse clicks, etc., from the user while the user interacts with the GUI of the electronic device. The operating system (OS) of the electronic device captures the received input data and records the input data in an OS log file. The operating system captures input/output events associated with the electronic device and saves the captured input/output events in the OS log file. The hotel room restaurant delivery system (HRRDS) or the hotel room restaurant delivery application (HRRDA) installed on the electronic device configures a processor of the electronic device to communicate with the operating system of the electronic device to retrieve one or more timestamps of the received inputs from the OS log file. In an embodiment, the HRRDA retrieves the timestamps from the OS log file, computes the time difference between the timestamps of two successive inputs, and compares the computed time difference between the timestamps of two successive inputs with the predetermined urgency threshold to determine the urgency level of the user's food requirement. The HRRDA then transmits the determined urgency level to the HRRDS via the communication network for further processing. In another embodiment, the HRRDA transmits the retrieved timestamps from the OS log file to the HRRDS via the communication network. In this embodiment, the HRRDS stores the retrieved timestamps of the inputs in that user's record in a database, for example, in a user management database. The HRRDS retrieves the timestamps from the user management database, computes the time difference between the timestamps of two successive inputs, and compares the time difference between the timestamps of two successive inputs with the predetermined urgency threshold to determine the urgency level of the user's food requirement. The HRRDS determines that the urgency level of the user's food requirement is high if the time difference between the timestamps of two successive inputs is lower than the predetermined urgency threshold.

Consider an example where a hotel guest initializes the hotel room restaurant delivery system (HRRDS) on the electronic device stationed at his/her hotel room and enters inputs at a hurried pace via the graphical user interface (GUI) of the electronic device. When the hotel guest enters inputs in the HRRDS, the HRRDS records the time, for example, in a format of hours, minutes, seconds, and milliseconds. In this example, consider that the hotel guest performs a first keystroke using a keyboard of the electronic device at 10 hr:30 min:32 s:09 ms and performs a second keystroke at, for example, 10 hr:30 min:32 s:18 ms. The HRRDS computes the time difference between the first keystroke and the second keystroke. If the predefined urgency threshold is, for example, 10 ms, and the computed time difference is below the predefined urgency threshold, for example, 9 ms in this example, then the HRRDS determines that the hotel guest is in a hurry and the urgency level is high. Similarly, the HRRDS computes the time difference between two successive computer mouse clicks and determines the urgency level of the hotel guest's food requirement. Furthermore, the HRRDS records the time in the format of hours, minutes, seconds, and milliseconds, for example, 10 hr:30 min:32 s:09 ms at which a new display screen is rendered to the hotel guest and the time in the format of hours, minutes, seconds, and milliseconds, for example, 10 hr:30 min:32 s:12 ms when the hotel guest responds to the new display screen via the GUI. The HRRDS computes the time difference between the time at which the new display screen is rendered on the GUI to the hotel guest and the time at which the hotel guest responds to the new display screen. If the predefined urgency threshold is, for example, 5 ms, and the computed time difference is less than the predefined urgency threshold, for example, 3 ms, then the HRRDS determines that the hotel guest is in a hurry and the urgency level is high. When the HRRDS determines that the urgency level of the hotel guest's food requirement is high, the HRRDS searches for restaurants that provide time specific food types, for example, fast food, to allow the hotel guest to select a time specific food type and proceed to the next step to browse the list of restaurants that offer the selected time specific food type, rendered by the HRRDS on the GUI of the electronic device.

The urgency level of the user's food requirement is computed by a specific computer program of the hotel room restaurant delivery system (HRRDS) that measures a rate of data entry through the graphical user interface (GUI) of the electronic device. This specific computer program analyzes a number of inputs in real time, while the user interacts with the HRRDS to place his/her order, and uses these inputs as variables within a complex formula that calculates an urgency index. This specific computer program is developed and tested to correctly and consistently compute the urgency index, which cannot be casually or randomly executed on a generic computer.

In another embodiment, the hotel room restaurant delivery system (HRRDS) provides an explicit tagging option in the form of an interface element, for example, a button labeled “Urgent” on the graphical user interface (GUI) to allow a user to indicate that a food requirement is urgent. If the user clicks the button labeled “Urgent”, the HRRDS searches for restaurants that provide time specific food types, for example, fast food, to allow the hotel guest to select a time specific food type and proceed to the next step to browse the list of restaurants that offer the selected time specific food type, rendered by the HRRDS on the GUI of the electronic device. In an embodiment, the HRRDS prompts the user to explicitly indicate whether an order is urgent on the GUI, and accordingly computes a rush surcharge on the order cost.

After determining the urgency level of the user's food requirement, the hotel room restaurant delivery system (HRRDS) determines and renders 103 multiple time specific food type options on the graphical user interface (GUI) of the electronic device based on the determined urgency level of the food requirement. The time specific food type options are defined by time taken to prepare the food by restaurants in a restaurant network and/or time taken to deliver the food by delivery personnel. The time specific food type options comprise, for example, fast food options, food options that can be delivered at a later time, food options that can be delivered at a time scheduled by the user, food options that can be delivered in the shortest possible time, etc. For example, if the HRRDS determines that the urgency level of the user's food requirement is high, the HRRDS determines and renders fast food options that take less time to prepare, on the GUI of the electronic device. In another example, if the HRRDS determines that the urgency level of the user's food requirement is high, the HRRDS determines and renders food options that can be delivered in the shortest possible time by delivery personnel who are located proximal to the hotel and proximal to restaurants near the hotel, on the GUI of the electronic device. In another example, if the HRRDS determines that the urgency level of the user's food requirement is low, the HRRDS determines and renders food options that may take a long time to prepare, on the GUI of the electronic device. In another example, if the HRRDS determines that the urgency level of the user's food requirement is low, the HRRDS determines and renders food options that can be delivered at a later time, on the GUI of the electronic device.

The user can then select one of the rendered time specific food type options on the GUI. For example, a visually impaired user provides a food type selection of one of the time specific food type options to the hotel room restaurant delivery system (HRRDS) by pressing the button configured on the electronic device to activate the voice interaction facility of the HRRDS and stating the food type selection by speaking to a customer service representative. The customer service representative can be reached at the press of the button configured on the electronic device. In another example, a hearing impaired user can enter his/her food type selection on the chat interface provided on the GUI by the HRRDS. The HRRDS receives and processes 104 the user's food type selection of one of the time specific food type options from the electronic device through one or more of the interface elements, for example, the button for the voice interaction facility, the chat interface, etc., via the GUI of the electronic device.

The hotel room restaurant delivery system (HRRDS) determines and renders 105 information, advertisements, and promotions of multiple restaurants proximal to the hotel room from the restaurant network on the graphical user interface (GUI) of the electronic device based on the received and processed food type selection of one of the time specific food type options and predetermined user criteria. The information of the restaurants comprises, for example, restaurant information, information on cuisines, the food menu, and supplementary information comprising, for example, news and activity information on online activities hosted by the HRRDS, offers, etc. The promotions comprise, for example, offers, free samples, discounts, etc., configured by the restaurants to publicize or advertise a product or a service. The HRRDS stores and maintains the information of the restaurants in one or more databases, for example, in a restaurant management database. The restaurant network comprises restaurants affiliated to the HRRDS. In an example, if the HRRDS determines the user's food requirement to be high, the HRRDS searches for restaurants that provide fast food, and render information, advertisements, and promotions of fast food restaurants proximal to the hotel room from the restaurant network on the GUI of the electronic device.

The hotel room restaurant delivery system (HRRDS) also determines and renders information, advertisements, and promotions of restaurants proximal to the hotel room from the restaurant network on the GUI of the electronic device based on predetermined user criteria. The predetermined user criteria refers to a set of filters that filter the list of restaurants to be rendered on the GUI of the electronic device, for example, based on a user's dining preferences, spending patterns, dietary restrictions, budget restrictions, locations of the restaurants, etc. In an embodiment, the HRRDS lists the restaurants, for example, in an alphabetical order and based on cuisines on the GUI of the electronic device. The HRRDS allows users to access the list of restaurants affiliated to the HRRDS, thereby allowing the users to interface with a food delivery network of the HRRDS in the vicinity of the hotel for food delivery to their hotel rooms. The HRRDS displays restaurants that offer food delivery in the vicinity of the hotel, thereby precluding the user from having to spend a lot of time searching for restaurants in the vicinity of the hotel. In an embodiment, the HRRDS provides a search tool to allow a user to locate a specific restaurant from the restaurant network of the HRRDS comprising multiple restaurants proximal to the hotel where the user is staying and filter the restaurants based on search filters.

On viewing the rendered information, advertisements, and promotions on the graphical user interface (GUI) of the electronic device, the user can click on a name of a restaurant on the GUI, which launches a food menu screen on the GUI to allow the user to select one or more food items to order from the food menu screen. The hotel room restaurant delivery system (HRRDS) receives and processes 106 a restaurant selection of one of the restaurants through one or more interface elements, for example, the button for the voice interaction facility, the chat interface, etc., via the GUI of the electronic device. For example, a visually impaired user provides the restaurant selection to the HRRDS by pressing the button configured on the electronic device to activate the voice interaction facility of the HRRDS and stating the restaurant selection by speaking to a customer service representative. In another example, a hearing impaired user can enter his/her restaurant selection on the chat interface provided on the GUI by the HRRDS.

On receiving the restaurant selection, the hotel room restaurant delivery system (HRRDS) launches a menu order screen that determines and renders 107 a food menu associated with the received and processed restaurant selection via the graphical user interface (GUI) of the electronic device. The user may then select one or more food items from the food menu through one or more interface elements via the GUI of the electronic device. For example, a visually impaired user provides a food selection to the HRRDS by pressing the button configured on the electronic device to activate the voice interaction facility of the HRRDS and stating the food selection by speaking to a customer service representative. In another example, a hearing impaired user enter his/her food selection on the chat interface provided by the HRRDS. The HRRDS receives and processes 108 the food selection of one or more food items from the food menu through one or more interface elements, for example, the button for the voice interaction facility, the chat interface, etc., via the GUI of the electronic device. The data inputted by the user, for example, the input keystrokes, computer mouse clicks, the food type selection, the restaurant selection, the food selection, etc., via the GUI of the electronic device stationed in the hotel room from where the food type selection, the restaurant selection, and the food selection are made, is processed, transformed, and executed by an algorithm in the HRRDS for transmission to another computer at the restaurant to allow urgent or delayed food ordered by the user from the hotel room to be fulfilled.

On receiving the food selection from the user via the graphical user interface (GUI), the hotel room restaurant delivery system (HRRDS), in communication with a restaurant management and delivery system of the selected restaurant via a communication network, for example, the internet, generates and renders 109 a sale order comprising user information and a net payable amount for the selected food items from the selected restaurant on the GUI of the electronic device along with default contact details, for example, the address and phone number of the hotel room. The restaurant management and delivery system is a computing system installed in each of the restaurants in the restaurant network affiliated to the HRRDS. The HRRDS, in communication with the restaurant management and delivery system of the selected restaurant via the communication network, performs 110 one or more actions associated with the sale order for delivering the selected food items from the selected restaurant to the hotel room. In an example of the actions performed on the sale order, the HRRDS receives and processes payment information, for example, credit card information for the sale order from the user via the GUI of the electronic device. In an embodiment, the HRRDS biometrically verifies user identification information for automatically processing payment for the sale order using the received payment information. In this embodiment, the electronic device stationed in the hotel room is configured with a biometric identification system that verifies the user's identity and allows payment to be automatically debited from the payment information stored in the HRRDS. In an embodiment, the HRRDS extracts the user information from the received payment information and displays the extracted user information in the sale order. The user identification information inputted by the user via the biometric identification system is transformed, processed and executed by an algorithm in the HRRDS for transmission to another computer, for example, at the user's bank for automatically processing payment for the sale order using the received payment information.

The hotel room restaurant delivery system (HRRDS) transmits the generated sale order to the restaurant management and delivery system of the selected restaurant via the communication network for the delivery of the selected food items from the selected restaurant to the hotel room. The HRRDS directs the sale order to an appropriate restaurant that can fulfill the sale order in the time required by the user after the sale order is generated. A generic computer using a generic program cannot interface instantaneously with computers in a selected restaurant located proximal to the hotel to transmit the sale order and have the sale order fulfilled by the selected restaurant and delivered to the user's hotel room, cannot determine the urgency level of the user's food requirement, and cannot direct the sale order to an appropriate restaurant that can fulfill the sale order in accordance with the determined urgency level of the user's food requirement.

In an embodiment, the restaurant management and delivery system is configured on an electronic device, for example, a computer, a server, etc., at each of the restaurants of the restaurant network to allow the restaurants to manage their operations to conform to standards of the hotel room restaurant delivery system (HRRDS). In an embodiment, the restaurant management and delivery system is incorporated in a backend management system that allows restaurants to organize information to be communicated to users via the HRRDS. The backend management system organizes and communicates the restaurant information to the electronic device stationed at the hotel room via the HRRDS. In another embodiment, the restaurant management and delivery system comprises a point-of-sale (POS) system that allows restaurants to control costs and provide an enhanced experience to customers, for example, hotel guests. In an embodiment, the POS system updates pricing of the food items based on user data, transaction data, and operational data generated by the HRRDS. The restaurant management and delivery system establishes a communication interface between the restaurants proximal to the hotel, the HRRDS on the electronic device stationed at the hotel room, and communication devices of delivery personnel to process the sale order and deliver the selected food items to the hotel room. The restaurant management and delivery system receives and processes the sale order and transmits the processed sale order to a delivery application executable by at least one processor on a communication device, for example, a mobile phone of delivery personnel via a communication network, for example, the internet for the delivery of the selected food items to the hotel room.

In an embodiment, the hotel room restaurant delivery system (HRRDS) generates a pickup and delivery route for each of multiple delivery personnel proximal to the selected restaurant based on one or more of predetermined delivery criteria. The predetermined delivery criteria comprise, for example, the number of sale orders generated from the hotel proximal to a current location of the delivery personnel, locations of the restaurants from where one or more food items defined in the sale orders have to be picked up, the locations of hotel rooms where the selected food items defined in the sale orders have to be delivered, distance between a location of each of the delivery personnel and the restaurants, distance between the restaurants and the hotel, traffic conditions from the restaurants to the hotel, a type of vehicle used by each of the delivery personnel, weather conditions, etc. The location information of the delivery personnel and the sale order information from the restaurant management and delivery system is processed, transformed, and executed by an algorithm in the HRRDS for generation of the pickup and delivery route, which is transmitted to the delivery personnel directly or through the restaurant management and delivery system of the selected restaurant.

In an embodiment, based on the determined urgency level of the user's food requirement, the hotel room restaurant delivery system (HRRDS) identifies delivery personnel nearest to the selected restaurant and to the hotel and computes the quickest delivery route for each of the identified delivery personnel to deliver the selected food items from the selected restaurant to the user at the hotel room. The HRRDS computes the quickest delivery route for each of the identified delivery personnel based on dynamic delivery criteria comprising, for example, distance between each delivery personnel and the selected restaurant, distance between the selected restaurant and the hotel, traffic conditions from the selected restaurant to the hotel, a type of vehicle used by the delivery personnel, weather conditions, etc., and selects the delivery personnel who would deliver the selected food items from the selected restaurant through the quickest delivery route to the hotel in the shortest amount of time possible. That is, the HRRDS selects one of the identified delivery personnel with a pickup and delivery route that allows the delivery of the selected food items from the selected restaurant to the hotel room in a substantially short time. In an embodiment, the HRRDS computes the quickest delivery route for each of the identified delivery personnel to deliver the selected food items to the hotel guest at the backend. A generic computer using a generic program cannot interface instantaneously with communication devices of delivery personnel located proximal to the hotel and to the selected restaurant to track the delivery personnel proximal the selected restaurant and the hotel, assign the sale order for a delivery transaction, and then monitor their position and progress of the delivery transaction.

The hotel room restaurant delivery system (HRRDS) designates delivery personnel, for example, through a binding service agreement contracted between the individual delivery personnel and the HRRDS. Duly contracted delivery personnel are provided with specially outfitted wireless portable communication devices, for example, tablets, that provide the following functionalities: allowing the HRRDS to track geographical locations of the tablets using built-in global positioning systems (GPSs); allowing the delivery personnel to communicate with the HRRDS via multiple communication modes, for example, voice communication, a short message service (SMS), chat, etc.; and allowing the delivery personnel to update information regarding each sale order and associated delivery transaction they are assigned to handle. The processes for tracking the delivery personnel nearest to the selected restaurant and the hotel, assigning the sale order for the delivery transaction, and then monitoring their position and progress of the delivery transaction are handled by specifically configured computer software that runs on enhanced servers of the HRRDS, and therefore cannot be accomplished using a generic computer.

The delivery application on the communication device of the delivery personnel configures or programs a processor of the communication device to communicate with a global positioning system (GPS) receiver of the communication device to retrieve GPS coordinates. The hotel room restaurant delivery system (HRRDS) communicates with the delivery application on the communication device via the communication network to retrieve the GPS coordinates and track the location of the delivery personnel's communication device. The HRRDS further determines real time vehicle traffic conditions via an external mapping service, for example, the Google Maps™ mapping service of Google Inc., using the retrieved GPS co-ordinates to calculate the shortest delivery route to the hotel having less vehicle traffic.

The hotel room restaurant delivery system (HRRDS) further performs other actions associated with the delivery of the selected food items defined in the sale order from the selected restaurant to the hotel room. For example, in an embodiment, the HRRDS, in communication with the delivery application on the delivery personnel's communication device via the communication network, monitors progress of the delivery of the selected food items. The HRRDS receives and processes a status and a position of the delivery of the selected food items in real time from the delivery application via the communication network and displays the status and the position on the GUI of the electronic device in the hotel room. In an embodiment, the HRRDS and/or the delivery application employ a global positioning system (GPS) for broadcasting the status and the position of the delivery in real time, and therefore allowing the user, for example, the hotel guest, the selected restaurant, and the HRRDS to monitor the progress of the delivery. In an embodiment, the HRRDS schedules a delivery time of the selected food items through the timepiece configured on the electronic device. For example, when food items are scheduled to be delivered at a particular time to the hotel guest's hotel room, the HRRDS sets an alarm on the timepiece of the electronic device to remind the hotel guest of the scheduled delivery.

In an embodiment, the hotel room restaurant delivery system (HRRDS) tracks, processes, and aggregates user data, search data, transaction data, operational data generated by the HRRDS, and the restaurant information of the restaurants in the restaurant network in one or more databases for analysis. The HRRDS determines user behavioral information comprising, for example, one or more of dining preferences, spending patterns, dietary restrictions, budget restrictions, locations, etc., using the aggregated user data, search data, transaction data, and operational data, and generates the predetermined user criteria for determining and rendering the information, advertisements, and promotions of the restaurants proximal to the hotel room from the restaurant network on the graphical user interface (GUI) of the electronic device by processing and transforming the determined user behavioral information. The determined user behavioral information allows the HRRDS to anticipate users' needs and provide an enhanced food experience to them. In an embodiment, the HRRDS records and stores data comprising, for example, each user's unique identifier, location, activity, behavior, orders, payment amount, payment mode, etc. The HRRDS processes, analyzes, and transforms the recorded data into a list of advertisements and promotions or offers to be rendered to the user via the GUI of the electronic device. The HRRDS generates a stream of advertisements and promotions or offers as output for targeting to the user based on the determined user behavioral information via the GUI of the electronic device stationed at the hotel room. The HRRDS transforms information gathered from both hotel guests and the restaurants into a unique ecosystem of business opportunities that generate revenue for the restaurants and satisfy the market demand for food. The aggregated user data, search data, transaction data, operational data generated by the HRRDS, and the restaurant information of the restaurants are transformed, processed and executed by an algorithm in the HRRDS for determining the user behavioral information and generating the predetermined user criteria for determining and rendering information, advertisements, and promotions of the restaurants proximal to the hotel room from the restaurant network on the GUI of the electronic device.

In an embodiment, the hotel room restaurant delivery system (HRRDS) allows advertisers to create and run offline database queries directly against one or more databases of the HRRDS, for example, the user management database to detect usage and preference patterns of the user based on the stored data comprising, for example, each user's unique identifier, location, activity, behavior, orders, payment amount, payment mode, etc. The HRRDS retrieves the user data and transaction data stored in the user management database based on the advertisers' queries. For example, an advertiser may submit a query for the number of users who order Mexican food such as Mexican chicken dishes in a selected location, for example, a selected city or a selected county, between a selected time range, for example, between 11 a.m. and 1 p.m. The advertiser may also submit a query for an average spend on Mexican chicken dishes during a particular time interval. The HRRDS creates specific database queries based on the submitted queries received from the advertiser to retrieve the user data from the user management database. The HRRDS saves the created database queries and runs the created database queries against the user management database according to the frequency required by the advertiser. The HRRDS generates reports reflecting the results of a database search run for the created database queries based on the advertisers' queries. The HRRDS allows each advertiser or partner restaurant to create and save multiple offline database queries.

For determination of the user behavioral information and usage and preference patterns of users, the hotel room restaurant delivery system (HRRDS) records every aspect of a user's interaction with the HRRDS in a database of transactions and activities, also referred to as the “user management database”. The HRRDS records the user's interactions comprising, for example, the user logging into the HRRDS, the user searching through special offers for a suitable offer, the user reading details of the offers, the user clicking one or more interface elements to initiate an ordering process, the user confirming the sale order, the user monitoring the progress of the delivery, the user's feedback comments and rating of the restaurant, the user logging out of the HRRDS, etc. The HRRDS records and saves additional information in the user management database corresponding to the user's interactions above. The additional information recorded comprises, for example, time between successive inputs received from the user via the graphical user interface (GUI), the time the user logged into the HRRDS, the time spent by the user browsing through various advertisements and special offers, the time a user spends viewing a specific advertisement or a special offer, the interaction of the user with each advertisement or special offer comprising, for example, clicks, scrolls, downloads, etc., completion of the sale order comprising, for example, amount paid, mode of payment, etc., further interaction with the restaurant by the user such as providing ratings, feedback comments, etc., the time the user signed out, etc. The HRRDS analyzes users' interaction data stored in the user management database and evaluates the relationship between the data based on ad hoc database queries.

In an embodiment of the computer implemented method disclosed herein, the design and flow of interactions between the hotel room restaurant delivery system (HRRDS), the electronic device stationed at the hotel room, the restaurant management and delivery system of the restaurant, and the communication device of the delivery personnel is deliberate, designed, and directed. Every prompt, every question, etc., the user receives via the graphical user interface (GUI) of the electronic device stationed at the hotel room is configured by the HRRDS to steer the user towards a finite set of predictable outcomes. The HRRDS implements one or more specific computer programs to direct the user towards a set of end results. The interactions designed by the HRRDS allows the HRRDS to collect information about the user, and from this information, through the use of another, separate and autonomous computer program, infer the user's preferences and intentions. This inference is used by the HRRDS as a trigger to generate advertisements and special offers that are most relevant and attractive to the user. To record the user's actions, infer his/her preferences and intentions, and prepare advertisements and special offers relevant to him/her requires, no less than three separate computer programs are required, which cannot be easily nor manually executed by a person working with a generic computer.

By determining the user behavioral information and usage and preference patterns of users, the hotel room restaurant delivery system (HRRDS) derives insights on dining patterns and preferences of aggregate groups of users to determine which restaurant offers promotions that best match the preferences and needs of these distinct groups of users. The HRRDS records and derives diner requirements, for example, in terms of dietary restrictions such as restrictions in sugar intake, etc., caloric requirements, available budget, type of food preferred, etc. The HRRDS then matches these requirements with entries in the user management database to provide advertisers or restaurants with suitable options within target identification parameters they provide. As disclosed above, the HRRDS creates any number and variety of queries against the user management database based on data generated from the use of the electronic device in the hotel room.

In an embodiment, the hotel room restaurant delivery system (HRRDS) displays advertisements, promotions, and offers of the restaurants proximal to the hotel as a default display on the graphical user interface (GUI) of the electronic device stationed in the hotel room. The user may accept or reject an offer on the GUI. If no offer interests the user, the user can close the default display and click on an interface element on the GUI to launch the food ordering process. The HRRDS receives and processes an acceptance or a rejection of the offer from the electronic device for triggering the restaurant selection and ordering process for the selected food items from the selected restaurant. In another embodiment, the HRRDS, in communication with the restaurant network, determines and renders advertisements and promotions of the restaurants proximal to the hotel room on the GUI of the electronic device stationed in the hotel room to target segments of users. As used herein, “target segments of users” refer to a target audience to whom the advertisements and the promotions are relevant.

The hotel room restaurant delivery system (HRRDS) receives and processes one or more of multiple target identification parameters from the restaurants of the restaurant network for identifying the target segments of users. The target identification parameters comprise, for example, location, demographics, meal preferences, and custom filter parameters that filter the target segments of users for rendering the advertisements and the promotions. For example, a restaurant owner or an advertiser may define the target identification parameters as Mexican chicken dishes ordered in San Jose, Calif. between a selected time range, for example, between 11 a.m. and 1 p.m. The target identification parameters inputted by advertisers, restaurant owners, etc., are processed, transformed, and executed by an algorithm in the HRRDS for identifying users and creating target segments of users. The HRRDS creates the target segments of users based on the received and processed target identification parameters configured by the restaurants using user profiles stored in one or more databases. The HRRDS physically stores the created target segments of users in one or more databases of the HRRDS, and not on the restaurants' computers or the restaurants' databases. The HRRDS provides access to selective data associated with the created target segments of users to the restaurants to allow the restaurants to customize and render the advertisements and the promotions to the created target segments of users over one or more channels. The HRRDS allows advertisers, restaurants, etc., to use the selective data of the created target segments of users to drive their campaigns. The HRRDS controls access of the information of the created target segments of users. The actual information of the created target segments of users is not visible to the advertisers, restaurants, etc. The selective data accessible to the advertisers, restaurants, etc., comprises, for example, X number of entries that match the target identification parameters. In an embodiment, the HRRDS provides a list of names of users in the target segments of users with their contact information, for example, phone numbers, electronic mail addresses, etc., to the advertisers, restaurants, etc., on receiving approval from the users.

The hotel room restaurant delivery system (HRRDS) assigns a unique and permanent user identification number (UID) to each user account. The HRRDS collects and stores the user data, for example, user behavior, activities, the user's current location, transactions, etc., in the user management database. The collected user data is processed, transformed, and executed by an algorithm in the HRRDS for determining relevant advertisements and special offers to be targeted to the created target segments of users. The HRRDS computes and renders relevant advertisements and special offers to a signed-in user via the graphical user interface (GUI) of the electronic device stationed in the hotel room based on the target identification parameters defined by advertisers or restaurants for their target audience. For example, an advertiser may specify target identification parameters such as male of age between 30 years to 45 years, married, currently living in the bay area, and has ordered Mexican chicken dishes over the last six months. The HRRDS identifies users with the specified target identification parameters and automatically computes which advertisements and special offers are relevant to each identified user for display on the GUI of the electronic device in the hotel room. When a hotel guest logs in to his/her user account via the GUI of the electronic device in his/her hotel room, the HRRDS identifies the user and location information and processes this information. If the user matches the target identification parameters specified by the advertiser, the HRRDS determines and renders the advertisements and offers of that particular advertiser for display on the GUI of the electronic device.

An advertiser can use one or more saved target segments of users as targets for an advertising campaign or a promotion campaign. Users registered with the hotel room restaurant delivery system (HRRDS) who belong to any of the saved target segments of users targeted by the advertiser receive advertising information through various HRRDS channels that comprise, for example, designated advertisement areas in online applications, mobile applications, and via messaging channels such as electronic mail (email) and social media. In an embodiment, the HRRDS dynamically updates the created target segments of users based on performance of the rendered advertisements and the rendered promotions. For example, the HRRDS retains the well-performing advertisements and promotions along with the target segments of users and the target identification parameters associated with the target segments of users. If the advertisements and promotions do not affect the target segments of users and hence do not perform well, the advertiser updates the target identification parameters and submits the updated target identification parameters to the HRRDS for creation of updated target segments of users. In an embodiment, the HRRDS hosts activities for engaging users and updating user profiles. The hosted activities comprise, for example, hosting on-platform contests, offering freebies, etc.

In an embodiment, the hotel room restaurant delivery system (HRRDS) detects and processes tasks performed by a user on the graphical user interface (GUI) of the electronic device and transforms the tasks into reward points to be credited to a user account based on task criteria defined by the HRRDS. As used herein, “reward points” refers to items of value, for example, virtual points, virtual currencies, etc., that can be allocated and converted into real or virtual points, currency, cash of value, etc., with one or more merchants, services, virtual products, virtual services, etc. The reward points comprise, for example, points, points redeemable for cash, points redeemable for items of value, scores, scores redeemable for cash, scores redeemable for items of value, cash, units of virtual currency, and other items of value. In the task criteria, the HRRDS defines predetermined tasks to be performed by the user, for example, referring other users to register with the HRRDS, booking a table or ordering a meal via the HRRDS, viewing an advertisement, etc. The HRRDS allows redemption of the reward points from the user account. The reward points provide value for specific tasks performed by individual users while using the HRRDS, tracks this value, and allows the users to redeem this value, for example, in the form of rewards, prizes, etc. In an embodiment, the redeemable reward points depend on deals struck with restaurants, advertisers, and other entities seeking to be promoted through a user base of the HRRDS.

In an embodiment, the hotel room restaurant delivery system (HRRDS) processes and transforms an order placed by a user from the hotel via the graphical user interface (GUI) of the electronic device stationed at the hotel room, to generate a sale order, and thereafter directs the sale order to multiple restaurants that can potentially fulfill the sale order. In this embodiment, the restaurants are required to input the time in which they can fulfill the sale order. The HRRDS processes and transforms the inputted times in accordance with criteria set by the user for the fulfillment of the sale order, for example, time to deliver the selected food items, the cost of the selected food items, etc. The HRRDS thereafter places the sale order with one or more restaurants. A generic computer using a generic program cannot fulfill the sale orders in accordance with the method steps identified above.

In another embodiment, the hotel room restaurant delivery system (HRRDS) processes and transforms an order placed by a user from the hotel via the graphical user interface (GUI) of the electronic device stationed at the hotel room to generate a sale order. The HRRDS then splits the generated sale order into one or more sub-orders to be fulfilled by one or more restaurants in accordance with criteria set by the user, for example, time to deliver the selected food items, cost of the selected food items, etc. A generic computer using a generic program cannot fulfill the sale order and sub-orders in accordance with the method steps identified above.

In an embodiment, users access the hotel room restaurant delivery system (HRRDS) by connecting to a uniform resource locator (URL) of a website of the HRRDS or by downloading the hotel room restaurant delivery application (HRRDA) of the HRRDS onto their mobile devices, and then signing in to or creating a user account. Both the website and the HRRDA provide access to network features and functions of the HRRDS via a set of navigational menus. The users fill up and maintain an online profile that records user data, for example, descriptive information such as location, age, gender, and ethnicity, transaction information such as last restaurant visited, food ordered, etc. At preconfigured time intervals, the HRRDS conducts on-platform activities such as contests and offers freebies to engage the users and collect information that is added to their user profiles stored in the user management database. The HRRDS also creates and maintains partnership agreements with restaurants and updates the restaurant management database with comprehensive information comprising, for example, food items on the food menu and corresponding prices, contact and address information, discount programs, promotions, etc., about each partner restaurant. The HRRDS compares information in the user profiles with the restaurant information and generates ad hoc target segments of users and promotional opportunities for the restaurants. In an embodiment, the HRRDS provides restaurants with an online tool for specifying which target segments of users to target or for defining target identification parameters of new target segments for the HRRDS to create. The HRRDS delivers special offers and promotional information to these target segments of users, for example, via a website and/or the HRRDA hosted by the HRRDS.

Consider an example of a hotel guest being hungry, but does not want to step out of his/her hotel room to dine. The hotel guest picks up the electronic device installed with the hotel room restaurant delivery system (HRRDS) stationed on a tabletop in the hotel room to search for a suitable restaurant via the graphical user interface (GUI) of the electronic device. The hotel guest can use the web based HRRDS or the preinstalled HRRDS on the electronic device. The hotel guest views advertisements and promotions of restaurants proximal to the hotel room on the GUI of the electronic device. In an embodiment, the HRRDS displays advertisements and promotions continuously in sequence as a default on the GUI when the electronic device is not in use. The hotel guest initiates the HRRDS and accepts or rejects the advertisements and promotions using an input interface, for example, a touchscreen interface on the electronic device, an input device such as a computer mouse, a keyboard, etc. The hotel guest can sign in to an existing user account or create a new account or continue as a guest user on the HRRDS via the GUI. If the hotel guest chooses to create a new user account, the HRRDS prompts the hotel guest to provide profile information, for example, name, location, age, gender, ethnicity, previous restaurants visited, food ordered, contact information, payment information, etc., on the GUI. The hotel guest enters the profile information on the GUI and submits the profile information to the HRRDS for creation of a user account.

When the hotel guest signs into the created user account, the hotel room restaurant delivery system (HRRDS) displays advertisements and promotions on the graphical user interface (GUI), for example, based on the hotel guest's dining preferences, spending patterns, dietary restrictions, caloric requirements, food type preferred, budget restrictions, locations, etc. Restaurants define target identification parameters, for example, dining preferences, spending patterns, etc., based on previous orders to create a separate target segment of users and narrow a prospective target segment of users for optimized delivery of relevant advertisements and promotions to the users. The HRRDS targets the advertisements and promotions to the hotel guest, if the user profile of the hotel guest matches the defined target identification parameters. The HRRDS scans one or more databases, for example, the user management database comprising the user data and transaction data for identifying users who satisfy the target identification parameters defined by the restaurants and filters out the users who do not satisfy the target identification parameters defined by the restaurants. The HRRDS transmits selective data, for example, the number of users in the target segment to the restaurants to protect the users' privacy.

The hotel room restaurant delivery system (HRRDS) allows restaurants to render advertisements and promotions to the target segments of users through different channels, for example, electronic mail (email), social media, mobile applications, etc. The HRRDS updates the list of restaurants who wish to target their advertisements and promotions to the hotel guest and maintains comprehensive information about each restaurant comprising, for example, food menus, food items, corresponding food prices, contact information, address information, discount programs, promotions, etc., in the restaurant management database. If the hotel guest accepts the rendered advertisements and promotions of a particular restaurant, then the HRRDS renders a food menu of the restaurant linked with the rendered advertisements and promotions on the GUI of the electronic device. If the hotel guest rejects the advertisements and promotions, then the HRRDS determines and renders a list of restaurants proximal to the hotel room on the GUI of the electronic device based on the predetermined user criteria to allow the hotel guest to select one of the restaurants of their choice from the list of restaurants and to obtain a food menu corresponding to the restaurant selection made. In an embodiment, the HRRDS determines and renders a list of restaurants proximal to the hotel room on the GUI of the electronic device based on a time specific food type option selected by the hotel guest from a list of time specific food type options rendered on the GUI based on the urgency level of the user's food requirement determined by the HRRDS.

When the hotel guest selects a restaurant, the hotel room restaurant delivery system (HRRDS) renders the food menu of the selected restaurant on the graphical user interface (GUI) of the electronic device. The hotel guest can then browse through the food menu of the selected restaurant and select one or more food items of interest and save them into a shopping cart on the GUI. The HRRDS then directs the hotel guest to a sale order page with the selected food items in the shopping cart, where the hotel guest reviews order details comprising the selected food items, quantity, price, delivery address, contact information of the hotel room, etc., before placing an order. After the hotel guest completes reviewing the order details, the hotel guest can proceed to the next step where the hotel guest can select a mode of payment and input payment information, for example, credit card information to complete payment for the order. The HRRDS then generates a sale order and allows the hotel guest to perform a final review of the order details and proceed to make a payment. The HRRDS processes the payment and forwards the sale order to the restaurant management and delivery system of the selected restaurant via the communication network, for example, the internet.

On receiving the sale order from the hotel room restaurant delivery system (HRRDS), restaurant staff attends to the sale order using the restaurant management and delivery system, fulfills the sale order, and then alerts delivery personnel to pick up the finished sale order. The delivery personnel receive an alert from the restaurant via the delivery application installed on the delivery personnel's communication device. To facilitate a timely delivery of the selected food items, the HRRDS utilizes independent delivery service providers and engages with them via a service level agreement to which each independent delivery service provider must abide. The HRRDS generates the service level agreement, for example, with the following requirements: the independent delivery personnel must have access to a delivery vehicle with an HRRDS brand on the delivery vehicle; the independent delivery personnel must agree to be available within an 8-hour period to pick up the sale order and deliver the food items defined in the sale order to the designated hotel room; each independent delivery personnel must have a communication device, for example, a smartphone, a tablet computing device, etc., with the HRRDS installed and with access to a communication network, for example, the internet, and with global positioning system capabilities for tracking the delivery personnel's location. The HRRDS generates and renders a pickup location and delivery route to the delivery application, for example, based on the number of sale orders generated proximal to the current location of the delivery personnel, location of the selected restaurant from where the selected food items defined in the sale order have to be picked up, and the location of the hotel where the selected food items defined in the sale order have to be delivered.

The delivery personnel receive the pickup location and delivery route from the hotel room restaurant delivery system (HRRDS) via the delivery application on their communication device. The hotel guest can monitor the progress of the sale order and track the position of the selected food items in real time via the GUI of the electronic device stationed in the hotel room. The HRRDS tracks the position of the selected food items using a navigation facility, for example, a global positioning system (GPS) built into the delivery personnel's communication device. The delivery personnel delivers the selected food items to the hotel room based on the address provided in the sale order and the delivery route mapped out by the HRRDS. The hotel guest receives the food items from the delivery personnel and acknowledges the delivery by signing on a delivery receipt which completes the sale order. The hotel guest receives reward points for performing tasks, for example, referring new users to the HRRDS, browsing through the offers, booking a table or ordering a meal via the HRRDS, etc., defined by the HRRDS and redeems the reward points, for example, for rewards, discounts, deals with the advertising restaurants, prizes, etc.

In an embodiment, the hotel room restaurant delivery system (HRRDS) configures the amount of reward points for each type of task performed and credits the reward points to the hotel guest's user account. In an example, when a user logs in to the HRRDS on the electronic device stationed in the hotel room, the HRRDS credits 50 points to the user account. When the user browses through a stream of advertisements and special offers, the HRRDS credits the user account with another 50 points. When the user clicks on a specific advertisement or a special offer, the HRRDS credits the user account with 100 points. When the user avails an advertised offer and orders one or more food items through the advertised offer, the HRRDS credits the user account with 500 points. When the user rates the restaurant and leaves feedback after completing the sale order, the HRRDS credits the user account with 100 points. The HRRDS credits the total points of 800 to the user account maintained in the user management database for using the HRRDS. The user can redeem the credited 800 points for merchandise, discounts, and other rewards. In an embodiment, the tasks and reward points assigned to the user account are arbitrary and the HRRDS may change the tasks and reward points at any time. In another embodiment, the reward points credited to the user account are time constrained.

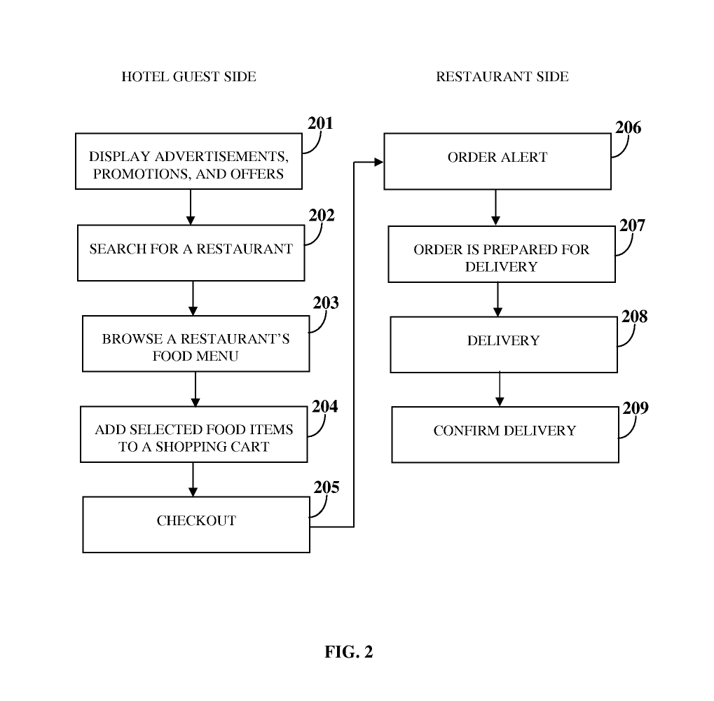

FIG. 2 exemplarily illustrates a process flow diagram showing an interaction between a hotel guest and a restaurant for ordering and delivery of food to a hotel room via an electronic device. The hotel room restaurant delivery system (HRRDS) displays 201 information, for example, restaurant information, information on cuisines, advertisements, latest offers, discounts, promotions, etc., offered by multiple restaurants in the restaurant network on the graphical user interface (GUI) of the electronic device. In an embodiment, a hotel guest can use a search tool provided by the HRRDS to search 202 for and locate a restaurant proximal to the hotel room or the hotel from the restaurant network. In an embodiment, the HRRDS generates a recommendation of a suitable restaurant based on the hotel guest's preferences, and in an embodiment, based on the hotel guest's urgency level, and displays the recommendation on the GUI of the electronic device. The hotel guest selects a restaurant and browses 203 through a food menu of the selected restaurant to select food items for purchase and delivery. The hotel guest selects one or more dishes or food items displayed in the food menu and adds 204 the selected food items to a shopping cart interface of the HRRDS. The HRRDS requests the hotel guest to confirm the selected food items and proceeds to checkout 205.

The hotel room restaurant delivery system (HRRDS) displays a summary or a recap of the selected food items and a sale order for the selected food items. The sale order comprises, for example, information of the selected food items, payment information, address, phone number, etc., of the hotel guest. The sale order shows the name of a buyer of the selected food items as “hotel guest” with the address, phone number, etc., of the hotel room as an automatic default. That is, the HRRDS populates the address and the phone number of the hotel room in the sale order by default. The HRRDS receives and processes payment information from the hotel guest via the GUI of the electronic device for the food items in the sale order and stores the payment information. The payment information comprises, for example, credit card information, a mode of payment through an electronic commerce gateway such as PayPal® of PayPal, Inc., user information such as name, credit card information, account information, etc. The servers of the HRRDS receive the sale order with the payment information, process the payment, and transfer the sale order to the restaurant management and delivery system, for example, via a point of sale system and/or a fax machine of the selected restaurant via the communication network for the delivery of the selected food items.

After checkout, the restaurant management and delivery system at the restaurant side generates an order alert 206. The selected restaurant prepares 207 the food items in the sale order for delivery 208. The restaurant management and delivery system forwards the sale order to the delivery application on the communication device of selected delivery personnel. The delivery application displays sale order data on a display interface provided by the delivery application on the delivery personnel's communication device to provide the delivery personnel with information required to pick up and deliver the selected food items to the hotel guest correctly. The hotel room restaurant delivery system (HRRDS), in communication with the restaurant management and delivery system via the communication network, manages one or more actions associated with the delivery of the selected food items in the sale order by the delivery personnel to the hotel room as disclosed in the detailed description of FIGS. 1A-1B. After delivering the selected food items to the hotel guest's hotel room, the delivery personnel confirms 209 the delivery of the selected food items via the delivery application.

Consider an example of a hotel guest being hungry, but does not want to step out of the hotel room to dine. The hotel guest picks up the electronic device installed with the hotel room restaurant delivery system (HRRDS) stationed on a tabletop in the hotel room and signs into his/her user account via the graphical user interface (GUI) at a slow pace. The HRRDS determines that the urgency level for the hotel guest's food requirement is low. Furthermore, based on the hotel guest's previous orders for only Indian food, the HRRDS configures the user criteria with Indian food as a food preference for this hotel guest. The HRRDS searches multiple databases for Indian restaurants proximal to the hotel where the hotel guest is staying. The HRRDS renders a list of four Indian restaurants a few minutes away from the hotel on the GUI, and further renders offers provided by two of the Indian restaurants. The hotel guest browses through the offers and the food menu of each of the restaurants and reads reviews provided by previous customers via the GUI. The hotel guest selects the Indian restaurant with the offer based on a best price for quality and the reviews provided by previous customers and selects one or more food items from the food menu of the selected Indian restaurant. The hotel guest adds the selected food items from the food menu into a shopping cart on the GUI and pays using a credit card. The HRRDS generates a sale order, confirms the order information, and processes the payment. The HRRDS transfers the sale order to the restaurant management and delivery system of the selected Indian restaurant. The HRRDS alerts the restaurant of the sale order of the hotel guest. The designated staff at the restaurant prepares the selected food items and endorses the sale order to delivery personnel, for example, to a delivery agent for delivery. The delivery agent delivers the selected food items to the hotel guest at his/her hotel through the delivery route generated by the HRRDS. The hotel guest receives the food he/she ordered and signs off on the sale order, thereby ending the transaction. The HRRDS tracks, processes, and aggregates user data, search data, transaction data, and operational data generated by the HRRDS in the user management database for further determination of the user behavioral information and for creation of target segments of users for advertisers.

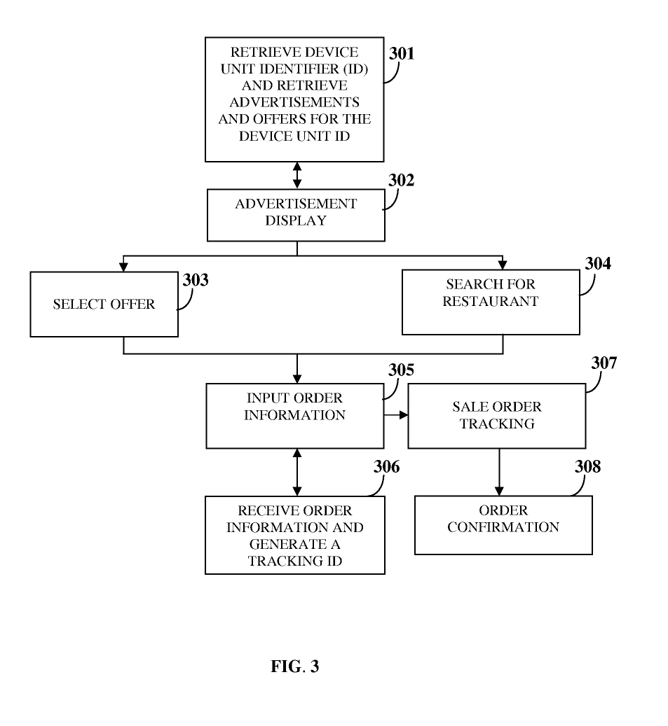

FIG. 3 exemplarily illustrates a process flow diagram comprising the steps performed by the hotel room restaurant delivery system (HRRDS) for allowing a user to order food from a restaurant and process a sale order for delivery of the food to a hotel room. The HRRDS used by the hotels is a customized hardware and software system installed in each of the electronic devices stationed in each of the hotel rooms, which allows hotel guests to order food from restaurants proximal to their hotel rooms and have the food delivered to their hotel rooms. The HRRDS operates on the electronic device and displays advertisements and promotions retrieved from the restaurant network on the graphical user interface (GUI) of the electronic device. The electronic device connects to designated servers of the HRRDS via a communication network. The HRRDS displays advertisements and promotions on the GUI of the electronic device stationed in the hotel room as a default display when the electronic device is not in use. When a hotel guest initializes the HRRDS on the electronic device stationed in the hotel room, the HRRDS retrieves 301 a device unit identifier (ID) of the electronic device and retrieves advertisements, promotions, etc., for that device unit ID. When a hotel guest logs into the user account maintained by the HRRDS, the HRRDS displays 302 advertisements and promotions relevant to the hotel guest from restaurants proximal to the hotel room via the GUI of the electronic device. The HRRDS provides options to the hotel guest to select 303 a promotional offer displayed on the GUI or search 304 for a restaurant. If the hotel guest accepts and selects the promotional offer, the HRRDS displays the food menu of the restaurant linked with the promotional offer. If the hotel guest rejects the promotional offer and proceeds to search for a suitable restaurant, the HRRDS displays the list of restaurants proximal to the hotel room for selection. On receiving the restaurant selection from the hotel guest, the HRRDS displays the food menu of the selected restaurant. The hotel guest then selects one or more food items from the food menu. The HRRDS receives and processes 305 the input order information and generates a sale order for the selected food items based on the food selection. The HRRDS also generates 306 a tracking identifier (ID) for tracking 307 the sale order. The HRRDS transmits the sale order with the tracking ID to the restaurant management and delivery system of the selected restaurant for fulfilling the sale order. The restaurant management and delivery system confirms 308 the sale order and alerts delivery personnel to pick up the fulfilled sale order. The delivery personnel receives the alert from the restaurant management and delivery system via the communication network, picks up the food items from the selected restaurant, and delivers the selected food items to the designated hotel room through the pickup and delivery route generated by the HRRDS and completes the transaction.

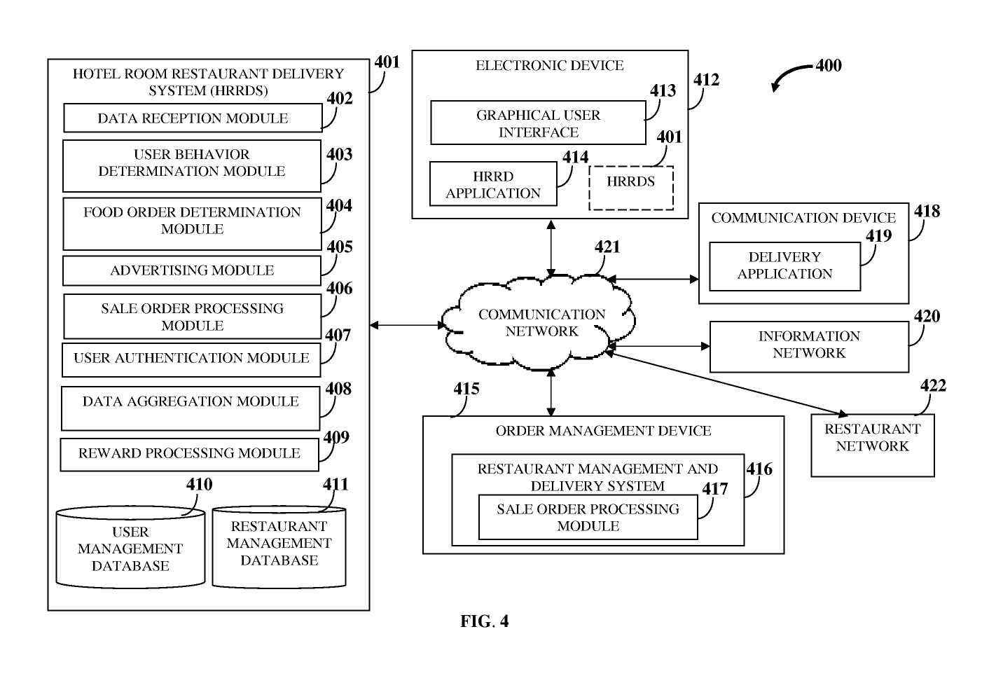

FIG. 4 exemplarily illustrates a computer implemented system 400 for ordering food from a restaurant for delivery to a hotel room via an electronic device 412 stationed in the hotel room. The electronic device 412 is, for example, a wireless portable computing device installed by the hotel in the hotel room to facilitate an ordering transaction. The computer implemented system 400 disclosed herein comprises the hotel room restaurant delivery system (HRRDS) 401 accessible by the electronic device 412 stationed in the hotel room, an order management device 415 of each of the restaurants in the restaurant network 422, an information network 420, and a communication device 418 of delivery personnel via a communication network 421. In the computer implemented system 400 disclosed herein, the HRRDS 401 interfaces with the electronic device 412, the restaurant management and delivery system 416 on the order management device 415, and the delivery application 419 on the communication device 418 to implement an ordering service for delivery of food items to a hotel room, and therefore more than one specifically programmed computing system is used for implementing the ordering service for delivery of the food items to the hotel room.

The hotel room restaurant delivery system (HRRDS) 401 is accessible to users, for example, hotel guests, restaurant owners, delivery personnel, etc., through a broad spectrum of technologies and devices such as personal computers with access to the internet, internet enabled cellular phones, tablet computing devices, etc. In an embodiment, the HRRDS 401 is installed on the electronic device 412 at the hotel room and is also implemented as the restaurant management and delivery system 416 on the order management device 415, for example, an internet enabled computing system at the restaurant. A restaurant network 422 comprising multiple partner restaurants affiliated to the HRRDS 401 and proximal to the hotel room also communicates with the HRRDS 401 via the communication network 421. In an embodiment, the information network 420 that stores and manages, for example, information on cuisines, advertisements such as food offers, promotions and discounts offered by the restaurants, etc., also communicates with the HRRDS 401 via the communication network 421. In an embodiment, the information network 420 is an underlying advertisement management and delivery network. The electronic device 412 functions as a delivery mechanism for an electronic display, advertising and information processing network.

The electronic device 412 stationed in the hotel room and the order management device 415 of each restaurant in the restaurant network 422 are computing devices, for example, personal computers, tablet computing devices, mobile computers, mobile phones, smart phones, portable computing devices, laptops, personal digital assistants, wearable devices such as Google Glass of Google Inc., touch centric devices, workstations, client devices, portable electronic devices, network enabled computing devices with a global positioning system (GPS), interactive network enabled communication devices, any other suitable computing equipment, combinations of multiple pieces of computing equipment, etc. For example, the electronic device 412 is a wireless portable computing device installed by the hotel in the hotel room to facilitate an ordering transaction. In an embodiment, the electronic device 412 is a hybrid device that combines the functionality of multiple devices. Examples of a hybrid device comprise a cellular telephone that includes media player functionality, a wireless portable mobile device with a voice interaction facility provided via a button configured on the electronic device 412 to enable visually impaired users to transact food orders with a customer service representative, a table computing device that includes a wireless communications capability such as an internet connection and a GPS, and a portable device that receives email, supports mobile telephone calls, has a music player functionality, and supports web browsing.

The restaurant management and delivery system 416 is installed on the order management device 415 of each restaurant. The order management device 415 is, for example, a personal computer, a tablet computing device, a laptop, a smart phone, a workstation, a network enabled computing device with a global positioning system (GPS), an interactive network enabled communication device, a point of sale system, a fax machine, any other suitable computing equipment, combinations of multiple pieces of computing equipment, etc. The communication device 418 of the delivery personnel is a mobile device, for example, a tablet computing device, a mobile computer, a mobile phone, a smart phone, a laptop, a personal digital assistant, a wearable device such as Google Glass of Google Inc., the Apple Watch of Apple Inc., etc.

The communication network 421 for accessing the hotel room restaurant delivery system (HRRDS) 401, the restaurant management and delivery system 416 on the order management device 415, and the delivery application 419 on the communication device 418 is, for example, the internet, an intranet, a wireless network, a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

In an embodiment, the hotel room restaurant delivery system (HRRDS) 401 is implemented as a software application downloadable and usable on the electronic device 412. In this embodiment, the HRRDS 401 is installed in the electronic device 412 at the hotel room for performing the steps of the computer implemented method disclosed in the detailed description of FIGS. 1A-1B. In an embodiment, the HRRDS 401 is implemented as a touch screen restaurant food ordering and delivery application, herein referred to as the “hotel room restaurant delivery application (HRRDA)” 414, on the electronic device 412 at the hotel room. In another embodiment, the HRRDS 401 is configured as a web based platform, for example, a website hosted on a server or a network of servers. In another embodiment, the HRRDS 401 is implemented in a cloud computing environment. As used herein, “cloud computing environment” refers to a processing environment comprising configurable computing physical and logical resources, for example, networks, servers, storage, applications, services, etc., and data distributed over the communication network 421, for example, the internet. The cloud computing environment provides on-demand network access to a shared pool of the configurable computing physical and logical resources. In an embodiment, the HRRDS 401 is developed, for example, using the Google App engine cloud infrastructure of Google Inc., Amazon Web Services® of Amazon Technologies, Inc., the Amazon elastic compute cloud EC2® web service of Amazon Technologies, Inc., the Google® Cloud platform of Google Inc., the Microsoft® Cloud platform of Microsoft Corporation, etc. In another embodiment, the HRRDS 401 is configured as a cloud computing based platform implemented as a service for allowing a user, for example, a hotel guest to order food from a restaurant for delivery to a hotel room via the electronic device 412 stationed in the hotel room.

In an embodiment, the hotel room restaurant delivery application (HRRDA) 414 that is downloaded on the electronic device 412 stationed in the hotel room communicates with the hotel room restaurant delivery system (HRRDS) 401 via the communication network 421. The HRRDS 401 provides a graphical user interface (GUI) 413 that is hosted on the electronic device 412 stationed in the hotel room. The GUI 413 is, for example, a webpage of a website hosted by the HRRDS 401, an online web interface, a web based downloadable application interface, a mobile based downloadable application interface, etc. The HRRDA 414 captures input data, user data, search data, transaction data, etc., via the GUI 413 and transmits the captured data to the HRRDS 401 via the communication network 421. The HRRDS 401 stores the received data in the user management database 410. In an embodiment, the GUI 413 is interoperable with a web based version of the HRRDS 401. The HRRDS 401 comprises a non-transitory computer readable storage medium and at least one processor communicatively coupled to the non-transitory computer readable storage medium. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium is configured to store computer program instructions defined by modules, for example, 402, 403, 404, 405, 406, 407, 408, 409, etc., of the HRRDS 401. The processor is configured to execute the defined computer program instructions.

The hotel room restaurant delivery system (HRRDS) 401 further comprises a data reception module 402, a user behavior determination module 403, a food order determination module 404, an advertising module 405, a sale order processing module 406, a user authentication module 407, a data aggregation module 408, a reward processing module 409, and one or more databases, for example, the user management database 410 and the restaurant management database 411. When a user activates the hotel room restaurant delivery application (HRRDA) 414 on the electronic device 412 via the graphical user interface (GUI) 413, the data reception module 402 receives input data entered by the user via the GUI 413, and the user behavior determination module 403 determines an urgency level of the user's food requirement by processing and transforming the input data received from the electronic device 412 as disclosed in the detailed description of FIGS. 1A-1B. The food order determination module 404 determines and renders multiple time specific food type options on the GUI 413 of the electronic device 412 based on the determined urgency level of the user's food requirement. The data reception module 402 receives and processes a food type selection of one of the time specific food type options from the electronic device 412 through one or more interface elements via the GUI 413 of the electronic device 412.

The advertising module 405 determines and renders information, advertisements, and promotions of multiple restaurants proximal to the hotel room from the restaurant network 422 on the graphical user interface (GUI) 413 of the electronic device 412 based on the received and processed food type selection of one of the time specific food type options and predetermined user criteria. In an embodiment, the advertising module 405 also displays information from the information network 420 associated with one or more restaurants from the restaurant network 422, received via the communication network 421, on the GUI 413 of the electronic device 412. The data reception module 402 further receives and processes a restaurant selection of one of the restaurants and a food selection of one or more food items from a food menu associated with the received and processed restaurant selection through one or more interface elements via the GUI 413 of the electronic device 412.

The sale order processing module 406 of the hotel room restaurant delivery system (HRRDS) 401 generates and renders a sale order comprising user information and a net payable amount for one or more food items based on the received and processed restaurant selection and the received and processed food selection on the graphical user interface (GUI) 413 of the electronic device 412. The sale order processing module 406 performs one or more actions associated with the sale order, in communication with the restaurant management and delivery system 416 of the selected restaurant via the communication network 421, for delivery of the selected food items to the hotel room. The sale order processing module 406 receives and processes payment information for the sale order via the GUI 413 of the electronic device 412. The sale order processing module 406 transmits the sale order with the payment information to a sale order processing module 417 of the restaurant management and delivery system 416 on the order management device 415 at the selected restaurant via the communication network 421 for delivery of the selected food items from the selected restaurant to the hotel room. In an embodiment, the user authentication module 407 biometrically verifies user identification information, that is, an identity of the hotel guest prior to processing the payment for the sale order using the received payment information. In this embodiment, on receiving a confirmation of the biometric verification from the sale order processing module 406 of the HRRDS 401, the HRRDS 401 allows the sale order processing module 417 of the restaurant management and delivery system 416 to automatically process the payment for the sale order using the received payment information.

The restaurant management and delivery system 416 on the order management device 415 comprises the sale order processing module 417 for processing the sale order received from the hotel room restaurant delivery system (HRRDS) 401 and performing restaurant specific functions. The restaurant specific functions comprise, for example, receiving the sale order from the HRRDS 401, identifying delivery personnel proximal to the restaurant and the hotel, determining delivery times from the delivery personnel, endorsing the sale order to the delivery personnel, etc. The restaurant management and delivery system 416 forwards the sale order to the delivery application 419 on the communication device 418 of the delivery personnel via the communication network 421. The delivery application 419 is executable by at least one processor on the communication device 418 of the delivery personnel. In an embodiment, the delivery application 419 on the delivery personnel's communication device 418 transmits in real time, the status and the position of the delivery of the selected food items to the restaurant management and delivery system 416 on the order management device 415. The restaurant management and delivery system 416 on the order management device 415 monitors progress of the delivery of the selected food items via a global positioning system and transmits in real time the status and the position of the delivery to the HRRDS 401 or the hotel room restaurant delivery application (HRRDA) 414 on the electronic device 412 in the hotel room.

In another embodiment, the delivery application 419 on the delivery personnel's communication device 418 transmits in real time, the status and the position of the delivery of the selected food items to the hotel room restaurant delivery system (HRRDS) 401 or the HRRDA 414 on the electronic device 412 in the hotel room directly. In this embodiment, the sale order processing module 406 of the HRRDS 401 monitors progress of the delivery of the selected food items, in communication with the delivery application 419 on the communication device 418 of the delivery personnel of the selected restaurant via the communication network 421. The sale order processing module 406 of the HRRDS 401 receives and processes a status and a position of the delivery of the selected food items in real time from the delivery application 419 via the communication network 421 and displays the status and the position on the GUI 413 of the electronic device 412 in the hotel room. In an embodiment, the sale order processing module 406 of the HRRDS 401 generates a pickup and delivery route for each of multiple delivery personnel proximal to the selected restaurant based on one or more of predetermined delivery criteria as disclosed in the detailed description of FIGS. 1A-1B. The sale order processing module 406 or 417 selects one of the delivery personnel with the pickup and delivery route that allows the delivery of the selected food items from the selected restaurant to the hotel room in a substantially short time.

The advertising module 405 of the hotel room restaurant delivery system (HRRDS) 401, in communication with the restaurant network 422, determines and renders advertisements and promotions of multiple restaurants on the graphical user interface (GUI) 413 of the electronic device 412 to target segments of users. The advertising module 405 receives and processes one or more target identification parameters from the restaurants of the restaurant network 422 for identifying the target segments of users. The advertising module 405 creates the target segments of users based on the received and processed target identification parameters configured by the restaurants, using user profiles stored in one or more databases, for example, the user management database 410. The advertising module 405 configures the processor of the HRRDS 401 to receive and process database queries from restaurants or advertisers and run the received database queries against the user profiles stored in the user management database 410 to create the target segments of users. The advertising module 405 provides access of selective data associated with the created target segments of users to the restaurants to allow the restaurants to customize and render the advertisements and the promotions to the created target segments of users over one or more channels. The advertising module 405 dynamically updates the created target segments of users based on performance of the rendered advertisements and the rendered promotions. The advertising module 405 renders information on cuisines, advertisements such as food offers, promotions and discounts offered by the advertisers, etc., from the information network 420 on the GUI 413 of the electronic device 412 via the communication network 421.

The data aggregation module 408 of the hotel room restaurant delivery system (HRRDS) 401 tracks, processes, and aggregates user data, search data, transaction data, and operational data generated by the HRRDS 401, and the information of the restaurants in the restaurant network 422 in one or more databases, for example, the user management database 410 and the restaurant management database 411. The user behavior determination module 403 of the HRRDS 401 determines user behavioral information comprising, for example, one or more of dining preferences, spending patterns, dietary restrictions, budget restrictions, and locations using the aggregated user data, search data, transaction data, and operational data. The user behavior determination module 403 then generates the predetermined user criteria for determining and rendering the information, the advertisements, and the promotions of the restaurants proximal to the hotel room from the restaurant network 422 on the graphical user interface (GUI) 413 of the electronic device 412 by processing and transforming the determined user behavioral information. The user behavior determination module 403 also hosts activities for engaging users and updating user profiles.

The reward processing module 409 of the hotel room restaurant delivery system (HRRDS) 401 detects and processes tasks performed by a user on the graphical user interface (GUI) 413 of the electronic device 412 and transforms the tasks into reward points to be credited to a user account based on task criteria defined by the HRRDS 401. The reward processing module 409 allows redemption of the reward points from the user account. The user management database 410 stores the aggregated user data, search data, transaction data, and operational data generated by the HRRDS 401, the user account details, reward point information, etc. The restaurant management database 411 stores information of the restaurants in the restaurant network 422. The user management database 410 and the restaurant management database 411 can be, for example, any of a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the user management database 410 and the restaurant management database 411 can also be locations on a file system. In another embodiment, the user management database 410 and the restaurant management database 411 can be remotely accessed by the HRRDS 401 via the communication network 421. In another embodiment, the user management database 410 and the restaurant management database 411 are configured as cloud based databases implemented in a cloud computing environment, where computing resources are delivered as a service over the communication network 421.

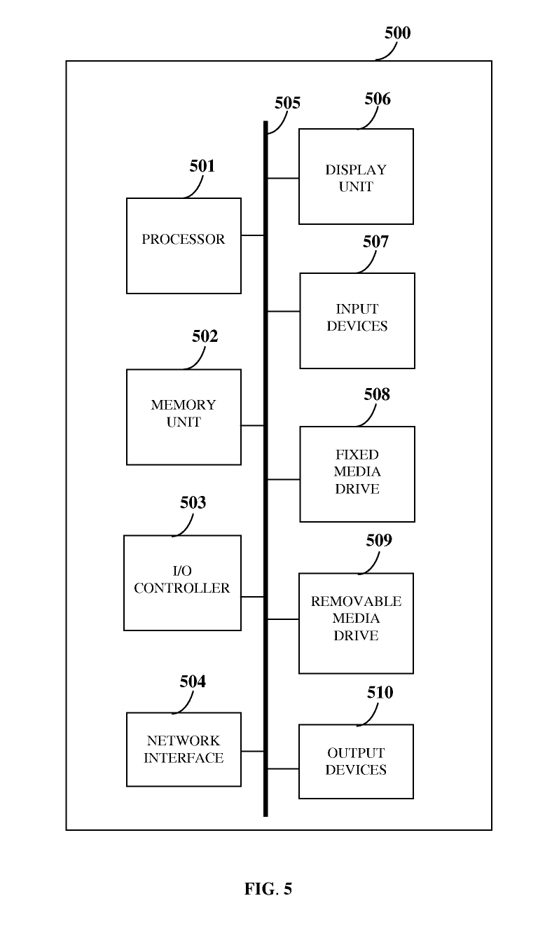

FIG. 5 exemplarily illustrates the hardware architecture 500 of the hotel room restaurant delivery system (HRRDS) 401 exemplarily illustrated in FIG. 4, for ordering food from a restaurant for delivery to a hotel room via an electronic device 412 exemplarily illustrated in FIG. 4, stationed in the hotel room. The HRRDS 401 is a computer system that is programmable using a high level computer programming language. In an embodiment, the HRRDS 401 is implemented using programmed and purposeful hardware. The HRRDS 401 communicates with the electronic device 412, the order management device 415, and the communication device 418 of the delivery personnel via the communication network 421 exemplarily illustrated in FIG. 4, for example, a short range network or a long range network, etc.

As exemplarily illustrated in FIG. 5, the hardware architecture 500 of the hotel room restaurant delivery system (HRRDS) 401 comprises a processor 501, a non-transitory computer readable storage medium such as a memory unit 502 for storing programs and data, an input/output (I/O) controller 503, a network interface 504, a data bus 505, a display unit 506, input devices 507, a fixed media drive 508 such as a hard drive, a removable media drive 509 for receiving removable media, output devices 510, etc. The processor 501 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. In an embodiment, the processor 501 is implemented as a processor set comprising, for example, a programmed microprocessor and a math or graphics co-processor. The processor 501 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The HRRDS 401 disclosed herein is not limited to employing a processor 501. In an embodiment, the HRRDS 401 employs a controller or a microcontroller. The processor 501 executes the modules, for example, 402, 403, 404, 405, 406, 407, 408, 409, etc., of the HRRDS 401 exemplarily illustrated in FIG. 4.

The memory unit 502 is used for storing programs, applications, and data. For example, the data reception module 402, the user behavior determination module 403, the food order determination module 404, the advertising module 405, the sale order processing module 406, the user authentication module 407, the data aggregation module 408, the reward processing module 409, etc., exemplarily illustrated in FIG. 4, are stored in the memory unit 502 of the hotel room restaurant delivery system (HRRDS) 401. The memory unit 502 is, for example, a random access memory (RAM) or another type of dynamic storage device that stores information and instructions for execution by the processor 501. The memory unit 502 also stores temporary variables and other intermediate information used during execution of the instructions by the processor 501. The HRRDS 401 further comprises a read only memory (ROM) or another type of static storage device that stores static information and instructions for the processor 501. The I/O controller 503 controls input actions and output actions performed by the HRRDS 401.

The network interface 504 enables connection of the hotel room restaurant delivery system (HRRDS) 401 to the communication network 421. In an embodiment, the network interface 504 is provided as an interface card also referred to as a line card. The network interface 504 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 505 permits communications between the modules, for example, 402, 403, 404, 405, 406, 407, 408, 409, 410, 411, etc., of the HRRDS 401.

The display unit 506, via the graphical user interface (GUI) 413 exemplarily illustrated in FIG. 4, displays information, display interfaces, user interface elements such as text fields, checkboxes, text boxes, windows, buttons, etc., for allowing the hotel guest to interact with the hotel room restaurant delivery system (HRRDS) 401. The display unit 506 comprises, for example, a liquid crystal display, a plasma display, an organic light emitting diode (OLED) based display, etc. The input devices 507 are used for inputting data into the HRRDS 401. The hotel guest uses the input devices 507 to provide inputs to the HRRDS 401. For example, a hotel guest may perform keystrokes, select a time specific food type, select an offer, select a restaurant, select one or more food items, enter payment information, etc., using the input devices 507. The input devices 507 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the hotel room restaurant delivery system (HRRDS) 401. The programs are loaded onto the fixed media drive 508 and into the memory unit 502 of the HRRDS 401 via the removable media drive 509. In an embodiment, the computer applications and programs are loaded directly via the communication network 421. Computer applications and programs are executed by double clicking a related icon displayed on the display unit 506 using one of the input devices 507. The output devices 510 output the results of operations performed by the HRRDS 401. For example, the HRRDS 401 displays a status and a position of the delivery of the selected food items from the selected restaurant to the hotel guest using the output devices 510.

The processor 501 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian™ operating system of Symbian Foundation Limited, etc. The hotel room restaurant delivery system (HRRDS) 401 employs the operating system for performing multiple tasks. The operating system is responsible for management and coordination of activities and sharing of resources of the HRRDS 401. The operating system further manages security of the HRRDS 401, peripheral devices connected to the HRRDS 401, and network connections. The operating system employed on the HRRDS 401 recognizes, for example, inputs provided by the users using one of the input devices 507, the output display, files, and directories stored locally on the fixed media drive 508. The operating system on the HRRDS 401 executes different programs using the processor 501. The processor 501 and the operating system together define a computer system for which application programs in high level programming languages are written.

The processor 501 of the hotel room restaurant delivery system (HRRDS) 401 retrieves instructions defined by the data reception module 402, the user behavior determination module 403, the food order determination module 404, the advertising module 405, the sale order processing module 406, the user authentication module 407, the data aggregation module 408, the reward processing module 409, etc., for performing respective functions disclosed in the detailed description of FIG. 4. The processor 501 retrieves instructions for executing the modules, for example, 402, 403, 404, 405, 406, 407, 408, 409, etc., of the HRRDS 401 from the memory unit 502. A program counter determines the location of the instructions in the memory unit 502. The program counter stores a number that identifies the current position in the program of each of the modules, for example, 402, 403, 404, 405, 406, 407, 408, 409, etc., of the HRRDS 401. The instructions fetched by the processor 501 from the memory unit 502 after being processed are decoded. The instructions are stored in an instruction register in the processor 501. After processing and decoding, the processor 501 executes the instructions, thereby performing one or more processes defined by those instructions.

At the time of execution, the instructions stored in the instruction register are examined to determine the operations to be performed. The processor 501 then performs the specified operations. The operations comprise arithmetic operations and logic operations. The operating system performs multiple routines for performing a number of tasks required to assign the input devices 507, the output devices 510, and memory for execution of the modules, for example, 402, 403, 404, 405, 406, 407, 408, 409, etc., of the hotel room restaurant delivery system (HRRDS) 401. The tasks performed by the operating system comprise, for example, assigning memory to the modules, for example, 402, 403, 404, 405, 406, 407, 408, 409, etc., of the HRRDS 401, and to data used by the HRRDS 401, moving data between the memory unit 502 and disk units, and handling input/output operations. The operating system performs the tasks on request by the operations and after performing the tasks, the operating system transfers the execution control back to the processor 501. The processor 501 continues the execution to obtain one or more outputs. The outputs of the execution of the modules, for example, 402, 403, 404, 405, 406, 407, 408, 409, etc., of the HRRDS 401 are displayed to the user on the display unit 506.

For purposes of illustration, the detailed description refers to the hotel room restaurant delivery system (HRRDS) 401 being run locally as a single computer system; however the scope of the computer implemented method and system 400 disclosed herein is not limited to the HRRDS 401 being run locally as a single computer system via the operating system and the processor 501, but may be extended to run remotely over the communication network 421 by employing a web browser and a remote server, a mobile phone, or other electronic devices. In an embodiment, one or more portions of the HRRDS 401 are distributed across one or more computer systems coupled to the communication network 421.

Disclosed herein is also a computer program product comprising a non-transitory computer readable storage medium having embodied thereon, computer program codes comprising instructions executable by at least one processor 501 for ordering food from a restaurant for delivery to a hotel room via an electronic device 412 stationed in the hotel room. The computer program product disclosed herein comprises a first computer program code for initializing the hotel room restaurant delivery system (HRRDS) 401 via the graphical user interface (GUI) 413 of the electronic device 412 stationed in the hotel room; a second computer program code for determining an urgency level of a user's food requirement by processing and transforming input data received from the electronic device 412; a third computer program code for determining and rendering multiple time specific food type options on the GUI 413 of the electronic device 412 based on the determined urgency level of the user's food requirement; a fourth computer program code for receiving and processing a food type selection of one of the time specific food type options from the electronic device 412 through one or more interface elements via the GUI 413 of the electronic device 412; a fifth computer program code for determining and rendering information, advertisements, and promotions of multiple restaurants proximal to the hotel room from a restaurant network 422 on the GUI 413 of the electronic device 412 exemplarily illustrated in FIG. 4, based on the received and processed food type selection of one of the time specific food type options and predetermined user criteria; a sixth computer program code for receiving and processing a restaurant selection of one of the restaurants and a food selection of one or more food items from a food menu associated with the received and processed restaurant selection through one or more interface elements via the GUI 413 of the electronic device 412; and a seventh computer program code for generating and rendering a sale order comprising user information and a net payable amount for the selected food items from the selected restaurant on the GUI 413 of the electronic device 412 and performing one or more actions associated with the sale order, in communication with the restaurant management and delivery system 416 of the selected restaurant via the communication network 421 exemplarily illustrated in FIG. 4, for the delivery of the selected food items from the selected restaurant to the hotel room.

In the computer program product disclosed herein, the fifth computer program code comprises an eighth computer program code for receiving and processing one or more of multiple target identification parameters from the restaurants of the restaurant network 422 for identifying target segments of users; a ninth computer program code for creating the target segments of users based on the received and processed target identification parameters configured by the restaurants using user profiles stored in one or more databases, for example, the user management database 410; and a tenth computer program code for providing access of selective data associated with the created target segments of users to the restaurants to allows the restaurants to customize and render the advertisements and the promotions to the created target segments of users over one or more channels.

The computer program product disclosed herein further comprises an eleventh computer program code for tracking, processing, and aggregating user data, search data, transaction data, operational data generated by the hotel room restaurant delivery system (HRRDS) 401, and the information of the restaurants in the restaurant network 422 in one or more databases, for example, the user management database 410; a twelfth computer program code for determining user behavioral information comprising, for example, one or more of dining preferences, spending patterns, dietary restrictions, budget restrictions, and locations using the aggregated user data, search data, transaction data, and operational data; and a thirteenth computer program code for generating the predetermined user criteria for determining and rendering the information, the advertisements, and the promotions of the restaurants proximal to the hotel room from the restaurant network 422 on the GUI 413 of the electronic device 412 by processing and transforming the determined user behavioral information. The computer program product disclosed herein further comprises a fourteenth computer program code for generating a pickup and delivery route for each of multiple delivery personnel proximal to the selected restaurant based on one or more of the predetermined delivery criteria.

The computer program product disclosed herein further comprises one or more additional computer program codes for performing additional steps that may be required and contemplated for ordering food from a restaurant for delivery to a hotel room via the electronic device 412 stationed in the hotel room. In an embodiment, a single piece of computer program code comprising computer executable instructions performs one or more steps of the computer implemented method disclosed herein for ordering food from a restaurant for delivery to a hotel room via the electronic device 412 stationed in the hotel room. The computer program codes comprising computer executable instructions are embodied on the non-transitory computer readable storage medium. The processor 501 of the hotel room restaurant delivery system (HRRDS) 401 retrieves these computer executable instructions and executes them. When the computer executable instructions are executed by the processor 501, the computer executable instructions cause the processor 501 to perform the steps of the computer implemented method for ordering food from a restaurant for delivery to a hotel room via the electronic device 412 stationed in the hotel room.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementation of the processes of various embodiments. Therefore, the embodiments are not limited to any specific combination of hardware and software. In general, the computer program codes comprising computer executable instructions may be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft®.NET etc. Other object-oriented, functional, scripting, and/or logical programming languages may also be used. In an embodiment, the computer program codes or software programs are stored on or in one or more mediums as object code. Various aspects of the computer implemented method and the hotel room restaurant delivery system (HRRDS) 401 exemplarily illustrated in FIG. 4, disclosed herein may be implemented as programmed elements, or non-programmed elements, or any suitable combination thereof. The computer program product disclosed herein comprises one or more computer program codes for implementing the processes of various embodiments.

Where databases are described such as the user management database 410 and the restaurant management database 411 exemplarily illustrated in FIG. 4, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the hotel room restaurant delivery system 401 exemplarily illustrated in FIG. 4, the databases may be integrated to communicate with each other for enabling simultaneous updates of data linked across the databases, when there are any updates to the data in one of the databases.

The computer implemented method and the hotel room restaurant delivery system 401 exemplarily illustrated in FIG. 4, disclosed herein can be configured to work in a network environment comprising one or more computers that are in communication with one or more devices via the communication network 421 exemplarily illustrated in FIG. 4. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to the communication network 421. Each of the computers and the devices executes an operating system, examples of which are disclosed above. While the operating system may differ depending on the type of computer, the operating system provides the appropriate communications protocols to establish communication links with the communication network 421. Any number and type of machines may be in communication with the computers.

The computer implemented method and the hotel room restaurant delivery system (HRRDS) 401 exemplarily illustrated in FIG. 4, disclosed herein are not limited to a particular computer system platform, processor, operating system, or network. One or more aspects of the computer implemented method and the HRRDS 401 disclosed herein may be distributed among one or more computer systems, for example, servers configured to provide one or more services to one or more client computers, or to perform a complete task in a distributed system. For example, one or more aspects of the computer implemented method and the HRRDS 401 disclosed herein may be performed on a client-server system that comprises components distributed among one or more server systems that perform multiple functions according to various embodiments. These components comprise, for example, executable, intermediate, or interpreted code, which communicate over a network using a communication protocol. The computer implemented method and the HRRDS 401 disclosed herein are not limited to be executable on any particular system or group of systems, and are not limited to any particular distributed architecture, network, or communication protocol.

The foregoing examples have been provided merely for the purpose of explanation and are in no way to be construed as limiting of the computer implemented method and the hotel room restaurant delivery system (HRRDS) 401 exemplarily illustrated in FIG. 4, disclosed herein. While the computer implemented method and the HRRDS 401 have been described with reference to various embodiments, it is understood that the words, which have been used herein, are words of description and illustration, rather than words of limitation. Further, although the computer implemented method and the HRRDS 401 have been described herein with reference to particular means, materials, and embodiments, the computer implemented method and the HRRDS 401 are not intended to be limited to the particulars disclosed herein; rather, the computer implemented method and the HRRDS 401 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the computer implemented method and the HRRDS 401 in their aspects.

I claim:

1. A computer implemented method for ordering food from a restaurant for delivery to a hotel room via an electronic device stationed in said hotel room, said method employing a hotel room restaurant delivery system comprising at least one processor configured to execute computer program instructions for performing said method, said method comprising:
initializing said hotel room restaurant delivery system via a graphical user interface of said electronic device stationed in said hotel room;
determining an urgency level of a food requirement by processing and transforming input data received from said electronic device by said hotel room restaurant delivery system;
determining and rendering a plurality of time specific food type options on said graphical user interface of said electronic device by said hotel room restaurant delivery system based on said determined urgency level of said food requirement;
receiving and processing a food type selection of one of said time specific food type options from said electronic device through one or more of a plurality of interface elements by said hotel room restaurant delivery system via said graphical user interface of said electronic device;
determining and rendering information, advertisements, and promotions of a plurality of restaurants proximal to said hotel room from a restaurant network by said hotel room restaurant delivery system on said graphical user interface of said electronic device based on said received and processed food type selection of said one of said time specific food type options and predetermined user criteria;
receiving and processing a restaurant selection of one of said restaurants and a food selection of one or more food items from a food menu associated with said received and processed restaurant selection through one or more of said interface elements by said hotel room restaurant delivery system via said graphical user interface of said electronic device; and
generating and rendering a sale order comprising user information and a net payable amount for said one or more food items based on said received and processed restaurant selection and said received and processed food selection on said graphical user interface of said electronic device and performing one or more actions associated with said sale order by said hotel room restaurant delivery system, in communication with a restaurant management and delivery system of said one of said restaurants based on said received and processed restaurant selection via a communication network, for said delivery of said one or more food items based on said received and processed food selection to said hotel room.

2. The computer implemented method of claim 1, wherein said one or more actions associated with said sale order comprise:
receiving and processing payment information for said sale order by said hotel room restaurant delivery system via said graphical user interface of said electronic device; and
transmitting said sale order by said hotel room restaurant delivery system to said restaurant management and delivery system of said one of said restaurants based on said received and processed restaurant selection via said communication network for said delivery of said one or more food items based on said received and processed food selection to said hotel room.

3. The computer implemented method of claim 1, wherein said one or more actions associated with said sale order comprise:
monitoring progress of said delivery of said one or more food items based on said received and processed food selection by said hotel room restaurant delivery system in communication with a delivery application executable by at least one processor on a communication device of delivery personnel via said communication network; and
receiving and processing a status and a position of said delivery of said one or more food items based on said received and processed food selection in real time by said hotel room restaurant delivery system from said delivery application via said communication network and displaying said status and said position on said graphical user interface of said electronic device in said hotel room.

4. The computer implemented method of claim 1, wherein said input data for said determination of said urgency level of said food requirement comprises a time of each successive input received via said graphical user interface of said electronic device, and wherein said processing and said transformation of said input data comprises determining a time difference between successive inputs received via said graphical user interface of said electronic device and comparing said determined time difference with a predefined urgency threshold by said hotel room restaurant delivery system.

5. The computer implemented method of claim 1, wherein said input data comprises an explicit indication of urgency of said food requirement received from said electronic device via said graphical user interface of said electronic device.

6. The computer implemented method of claim 1, wherein said time specific food type options are defined by time taken to one of prepare said food by said restaurants in said restaurant network, deliver said food by delivery personnel, and a combination thereof.

7. The computer implemented method of claim 1, wherein said information of said restaurants comprises restaurant information, information on cuisines, said food menu, and supplementary information comprising news and activity information.

8. The computer implemented method of claim 1, wherein said determination and said rendering of said advertisements and said promotions of said restaurants on said graphical user interface of said electronic device by said hotel room restaurant delivery system, in communication with said restaurant network, comprises:
receiving and processing one or more of a plurality of target identification parameters from said restaurants of said restaurant network for identifying target segments of users by said hotel room restaurant delivery system;
creating said target segments of users based on said received and processed one or more of said target identification parameters configured by said restaurants, by said hotel room restaurant delivery system using user profiles stored in one or more databases; and
providing access of selective data associated with said created target segments of users to said restaurants to allow said restaurants to customize and render said advertisements and said promotions to said created target segments of users over one or more channels.

9. The computer implemented method of claim 8, further comprising dynamically updating said created target segments of users by said hotel room restaurant delivery system based on performance of said rendered advertisements and said rendered promotions.

10. The computer implemented method of claim 8, wherein said target identification parameters comprise location, demographics, meal preferences, and custom filter parameters that filter said target segments of users for said rendering of said advertisements and said promotions.

11. The computer implemented method of claim 1, further comprising tracking, processing, and aggregating user data, search data, transaction data, operational data generated by said hotel room restaurant delivery system, and said information of said restaurants in said restaurant network in one or more databases.

12. The computer implemented method of claim 11, further comprising determining user behavioral information comprising one or more of dining preferences, spending patterns, dietary restrictions, budget restrictions, and locations by said hotel room restaurant delivery system using said aggregated user data, said search data, said transaction data, and said operational data, and generating said predetermined user criteria for said determination and said rendering of said information, said advertisements, and said promotions of said restaurants proximal to said hotel room from said restaurant network on said graphical user interface of said electronic device by said hotel room restaurant delivery system by processing and transforming said determined user behavioral information.

13. The computer implemented method of claim 1, further comprising generating a pickup and delivery route for each of a plurality of delivery personnel proximal to said one of said restaurants by said hotel room restaurant delivery system based on one or more of predetermined delivery criteria, wherein said predetermined delivery criteria comprise a number of sale orders generated from a hotel proximal to a current location of said delivery personnel, locations of said restaurants from where said one or more food items defined in said sale orders have to be picked up, locations of hotel rooms where said one or more food items defined in said sale orders have to be delivered, distance between a location of said each of said delivery personnel and said restaurants, distance between said restaurants and said hotel, traffic conditions from said restaurants to said hotel, a type of vehicle used by said each of said delivery personnel, and weather conditions.

14. The computer implemented method of claim 13, further comprising selecting one of said delivery personnel with said generated pickup and delivery route that allows said delivery of said one or more food items based on said received and processed food selection to said hotel room in a substantially short time by said hotel room restaurant delivery system.

15. The computer implemented method of claim 1, further comprising detecting and processing tasks performed on said graphical user interface of said electronic device, transforming said tasks into reward points to be credited to a user account by said hotel room restaurant delivery system based on task criteria defined by said hotel room restaurant delivery system, and allowing redemption of said reward points from said user account by said hotel room restaurant delivery system.

16. The computer implemented method of claim 1, further comprising hosting activities for engaging users and updating user profiles by said hotel room restaurant delivery system.

17. The computer implemented method of claim 1, wherein said interface elements are configured to receive inputs from users with disabilities via said graphical user interface of said electronic device.

18. The computer implemented method of claim 1, further comprising biometrically verifying user identification information by said hotel room restaurant delivery system for automatically processing payment for said sale order using payment information received for said sale order by said hotel room restaurant delivery system via said graphical user interface of said electronic device.

19. The computer implemented method of claim 1, further comprising scheduling one or more of wake up calls and a delivery time of said one or more food items by said hotel room restaurant delivery system through a timepiece configured on said electronic device.

20. A hotel room restaurant delivery system for ordering food from a restaurant for delivery to a hotel room via an electronic device stationed in said hotel room, said hotel room restaurant delivery system comprising:
a non-transitory computer readable storage medium configured to store computer program instructions defined by modules of said hotel room restaurant delivery system;
at least one processor communicatively coupled to said non-transitory computer readable storage medium, said at least one processor configured to execute said defined computer program instructions; and
said modules of said hotel room restaurant delivery system comprising:
a user behavior determination module configured to determine an urgency level of a food requirement by processing and transforming input data received from said electronic device, on initialization of said hotel room restaurant delivery system via a graphical user interface of said electronic device stationed in said hotel room;
a food order determination module configured to determine and render a plurality of time specific food type options on said graphical user interface of said electronic device based on said determined urgency level of said food requirement;
a data reception module configured to receive and process a food type selection of one of said time specific food type options from said electronic device through one or more of a plurality of interface elements via said graphical user interface of said electronic device;
an advertising module configured to determine and render information, advertisements, and promotions of a plurality of restaurants proximal to said hotel room from a restaurant network on said graphical user interface of said electronic device based on said received and processed food type selection of said one of said time specific food type options and predetermined user criteria;
said data reception module further configured to receive and process a restaurant selection of one of said restaurants and a food selection of one or more food items from a food menu associated with said received and processed restaurant selection through one or more of said interface elements via said graphical user interface of said electronic device; and
a sale order processing module configured to generate and render a sale order comprising user information and a net payable amount for said one or more food items based on said received and processed restaurant selection and said received and processed food selection on said graphical user interface of said electronic device, said sale order processing module further configured to perform one or more actions associated with said sale order, in communication with a restaurant management and delivery system of said one of said restaurants based on said received and processed restaurant selection via a communication network, for said delivery of said one or more food items based on said received and processed food selection to said hotel room.

21. The hotel room restaurant delivery system of claim 20, wherein said sale order processing module is further configured to perform:
receiving and processing payment information for said sale order via said graphical user interface of said electronic device; and
transmitting said sale order to said restaurant management and delivery system of said one of said restaurants based on said received and processed restaurant selection via said communication network for said delivery of said one or more food items based on said received and processed food selection to said hotel room.

22. The hotel room restaurant delivery system of claim 20, wherein said sale order processing module is further configured to perform:
monitoring progress of said delivery of said one or more food items based on said received and processed food selection, in communication with a delivery application executable by at least one processor on a communication device of delivery personnel based on said received and processed restaurant selection via said communication network; and
receiving and processing a status and a position of said delivery of said one or more food items based on said received and processed food selection in real time from said delivery application via said communication network and displaying said status and said position on said graphical user interface of said electronic device in said hotel room.

23. The hotel room restaurant delivery system of claim 20, wherein said input data for said determination of said urgency level of said food requirement comprises a time of each successive input received via said graphical user interface of said electronic device, and wherein said user behavior determination module is configured to process and transform said time of said each successive input, determine a time difference between successive inputs received via said graphical user interface of said electronic device, and compare said determined time difference with a predefined urgency threshold.

24. The hotel room restaurant delivery system of claim 20, wherein said time specific food type options are defined by time taken to one of prepare said food by said restaurants in said restaurant network, deliver said food by delivery personnel, and a combination thereof.

25. The hotel room restaurant delivery system of claim 20, wherein said advertising module is configured to determine and render said advertisements and said promotions of said restaurants on said graphical user interface of said electronic device to target segments of users, in communication with said restaurant network, by performing:
receiving and processing one or more of a plurality of target identification parameters from said restaurants of said restaurant network for identifying said target segments of users;
creating said target segments of users based on said received and processed one or more of said target identification parameters configured by said restaurants, using user profiles stored in one or more databases; and
providing access of selective data associated with said created target segments of users to said restaurants to allow said restaurants to customize and render said advertisements and said promotions to said created target segments of users over one or more channels.

26. The hotel room restaurant delivery system of claim 25, wherein said advertising module is further configured to dynamically update said created target segments of users based on performance of said rendered advertisements and said rendered promotions.

27. The hotel room restaurant delivery system of claim 25, wherein said target identification parameters comprise location, demographics, meal preferences, and custom filter parameters that filter said target segments of users for said rendering of said advertisements and said promotions.

28. The hotel room restaurant delivery system of claim 20, wherein said modules of said hotel room restaurant delivery system further comprise a data aggregation module configured to track, process, and aggregate user data, search data, transaction data, operational data generated by said hotel room restaurant delivery system, and said information of said restaurants in said restaurant network in one or more databases.

29. The hotel room restaurant delivery system of claim 28, wherein said user behavior determination module is further configured to determine user behavioral information comprising one or more of dining preferences, spending patterns, dietary restrictions, budget restrictions, and locations using said aggregated user data, said search data, said transaction data, and said operational data, and wherein said user behavior determination module is further configured to generate said predetermined user criteria for said determination and said rendering of said information, said advertisements, and said promotions of said restaurants proximal to said hotel room from said restaurant network on said graphical user interface of said electronic device by processing and transforming said determined user behavioral information.

30. The hotel room restaurant delivery system of claim 20, wherein said sale order processing module is further configured to generate a pickup and delivery route for each of a plurality of delivery personnel proximal to said one of said restaurants based on one or more of predetermined delivery criteria, wherein said predetermined delivery criteria comprise a number of sale orders generated from a hotel proximal to a current location of said delivery personnel, locations of said restaurants from where said one or more food items defined in said sale orders have to be picked up, locations of hotel rooms where said one or more food items defined in said sale orders have to be delivered, distance between a location of said each of said delivery personnel and said restaurants, distance between said restaurants and said hotel, traffic conditions from said restaurants to said hotel, a type of vehicle used by said each of said delivery personnel, and weather conditions.

31. The hotel room restaurant delivery system of claim 30, wherein said sale order processing module is further configured to select one of said delivery personnel with said generated pickup and delivery route that allows said delivery of said one or more food items based on said received and processed food selection to said hotel room in a substantially short time.

32. The hotel room restaurant delivery system of claim 20, wherein said modules of said hotel room restaurant delivery system further comprise a reward processing module configured to detect and process tasks performed on said graphical user interface of said electronic device, transform said tasks into reward points to be credited to a user account based on task criteria defined by said hotel room restaurant delivery system, and allow redemption of said reward points from said user accounts.

33. The hotel room restaurant delivery system of claim 20, wherein said user behavior determination module is further configured to host activities for engaging users and updating user profiles.

34. The hotel room restaurant delivery system of claim 20, wherein said modules of said hotel room restaurant delivery system further comprise a user authentication module configured to biometrically verify user identification information for automatically processing payment for said sale order using payment information received for said sale order via said graphical user interface of said electronic device.

35. A computer program product comprising a non-transitory computer readable storage medium having embodied thereon, computer program codes comprising instructions executable by at least one processor for ordering food from a restaurant for delivery to a hotel room via an electronic device stationed in said hotel room, said computer program codes comprising:
a first computer program code for initializing a hotel room restaurant delivery system via a graphical user interface of said electronic device stationed in said hotel room;
a second computer program code for determining an urgency level of a food requirement by processing and transforming input data received from said electronic device;
a third computer program code for determining and rendering a plurality of time specific food type options on said graphical user interface of said electronic device based on said determined urgency level of said food requirement;
a fourth computer program code for receiving and processing a food type selection of one of said time specific food type options from said electronic device through one or more of a plurality of interface elements via said graphical user interface of said electronic device;
a fifth computer program code for determining and rendering information, advertisements, and promotions of a plurality of restaurants proximal to said hotel room from a restaurant network on said graphical user interface of said electronic device based on said received and processed food type selection of said one of said time specific food type options and predetermined user criteria;
a sixth computer program code for receiving and processing a restaurant selection of one of said restaurants and a food selection of one or more food items from a food menu associated with said received and processed restaurant selection through one or more of said interface elements via said graphical user interface of said electronic device; and
a seventh computer program code for generating and rendering a sale order comprising user information and a net payable amount for said one or more food items based on said received and processed restaurant selection and said received and processed food selection on said graphical user interface of said electronic device and performing one or more actions associated with said sale order, in communication with a restaurant management and delivery system of said one of said restaurants based on said received and processed restaurant selection via a communication network, for said delivery of said one or more food items based on said received and processed food selection to said hotel room.

36. The computer program product of claim 35, wherein said fifth computer program code comprises:
an eighth computer program code for receiving and processing one or more of a plurality of target identification parameters from said restaurants of said restaurant network for identifying target segments of users;
a ninth computer program code for creating said target segments of users based on said received and processed one or more of said target identification parameters configured by said restaurants using user profiles stored in one or more databases; and
a tenth computer program code for providing access of selective data associated with said created target segments of users to said restaurants to allow said restaurants to customize and render said advertisements and said promotions to said created target segments of users over one or more channels.

37. The computer program product of claim 35, further comprising:
an eleventh computer program code for tracking, processing, and aggregating user data, search data, transaction data, operational data generated by said hotel room restaurant delivery system, and said information of said restaurants in said restaurant network in one or more databases;
a twelfth computer program code for determining user behavioral information comprising one or more of dining preferences, spending patterns, dietary restrictions, budget restrictions, and locations using said aggregated user data, said search data, said transaction data, and said operational data; and
a thirteenth computer program code for generating said predetermined user criteria for said determination and said rendering said information, said advertisements, and said promotions of said restaurants proximal to said hotel room from said restaurant network on said graphical user interface of said electronic device by processing and transforming said determined user behavioral information.

38. The computer program product of claim 35, further comprising a fourteenth computer program code for generating a pickup and delivery route for each of a plurality of delivery personnel proximal to said one of said restaurants based on one or more of predetermined delivery criteria, wherein said predetermined delivery criteria comprise a number of sale orders generated from a hotel proximal to a current location of said delivery personnel, locations of said restaurants from where said one or more food items defined in said sale orders have to be picked up, locations of hotel rooms where said one or more food items defined in said sale orders have to be delivered, distance between a location of said each of said delivery personnel and said restaurants, distance between said restaurants and said hotel, traffic conditions from said restaurants to said hotel, a type of vehicle used by said each of said delivery personnel, and weather conditions.
